(19) United States
(12) Patent Application Publication
(10) Pub. No.: US 2025/0055666 A1
(43) Pub. Date: Feb. 13, 2025

(54) TIME-DIVISION DUPLEX (TDD) CARRIER AGGREGATION (CA) WITH NON-CELL DEFINING (NCD) SIGNALING

(71) Applicant: QUALCOMM Incorporated, San Diego, CA (US)

(72) Inventors: Kazuki TAKEDA, Tokyo (JP); Jing LEI, San Diego, CA (US)

(21) Appl. No.: 18/447,841

(22) Filed: Aug. 10, 2023

(51) Int. Cl. H04L 5/16; H04L 5/00; H04W 48/08

(52) U.S. Cl. CPC H04L 5/16; H04L 5/001; H04W 48/08

(57) ABSTRACT

An apparatus may include one or more memories, individually or in combination, having instructions. The apparatus may further include one or more processors, individually or in combination, configured to execute the instructions and cause the apparatus to: output for transmission an indication of whether the apparatus is capable of supporting half-duplex communications via time-division duplex (TDD) carrier aggregation (CA); and obtain a command configured to enable collision handling by the apparatus, the command being based on the capability supported by the apparatus.

### BACKGROUND

### Technical Field

The present disclosure generally relates to wireless communication systems, and more particularly, to communication of non-cell defining synchronization signal blocks (NCD-SSB) in inter-band time-division duplex (TDD) carrier aggregation (CA).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Certain aspects are directed to an apparatus for wireless communication, comprising: one or more memories, individually or in combination, having instructions; and one or more processors, individually or in combination, configured to execute the instructions and cause the apparatus to: output for transmission an indication of whether the apparatus is capable of supporting half-duplex communications via time-division duplex (TDD) carrier aggregation (CA); and obtain a command configured to enable collision handling by the apparatus, the command being based on the capability supported by the apparatus.

Certain aspects are directed to an apparatus for wireless communication, comprising: one or more memories, individually or in combination, having instructions; and one or more processors, individually or in combination, configured to execute the instructions and cause the apparatus to: obtain, from a user equipment (UE), an indication of whether the UE is capable of supporting half-duplex communications via time-division duplex (TDD) carrier aggregation (CA); and output, for transmission to the UE, a command configured to enable collision handling at the UE, the command being output based on the capability supported by the UE.

Certain aspects are directed to a method for wireless communication at an apparatus, comprising: outputting for transmission an indication of whether the apparatus is capable of supporting half-duplex communications via time-division duplex (TDD) carrier aggregation (CA); and obtaining a command configured to enable collision handling by the apparatus, the command being based on the capability supported by the apparatus.

Certain aspects are directed to a method for wireless communication at an apparatus, comprising: obtaining, from a user equipment (UE), an indication of whether the UE is capable of supporting half-duplex communications via time-division duplex (TDD) carrier aggregation (CA); and outputting, for transmission to the UE, a command configured to enable collision handling at the UE, the command being output based on the capability supported by the UE.

Certain aspects are directed to an apparatus, comprising: means for outputting for transmission an indication of whether the apparatus is capable of supporting half-duplex communications via time-division duplex (TDD) carrier aggregation (CA); and means for obtaining a command configured to enable collision handling by the apparatus, the command being based on the capability supported by the apparatus.

Certain aspects are directed to an apparatus, comprising: means for obtaining, from a user equipment (UE), an indication of whether the UE is capable of supporting half-duplex communications via time-division duplex (TDD) carrier aggregation (CA); and means for outputting, for transmission to the UE, a command configured to enable collision handling at the UE, the command being output based on the capability supported by the UE.

Certain aspects are directed to a non-transitory computer-readable medium comprising instructions that, when executed by an apparatus, cause the apparatus to perform operations, comprising: outputting for transmission an indication of whether the apparatus is capable of supporting half-duplex communications via time-division duplex (TDD) carrier aggregation (CA); and obtaining a command configured to enable collision handling by the apparatus, the command being based on the capability supported by the apparatus.

Certain aspects are directed to a non-transitory computer-readable medium comprising instructions that, when executed by an apparatus, cause the apparatus to perform operations: obtaining, from a user equipment (UE), an indication of whether the UE is capable of supporting half-duplex communications via time-division duplex (TDD) carrier aggregation (CA); and outputting, for transmission to the UE, a command configured to enable collision handling at the UE, the command being output based on the capability supported by the UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a block diagram illustrating an example disaggregated base station architecture.

FIG. 5 is a block diagram conceptually illustrating an example set of bandwidth parts (BWPs) that a UE may be configured to monitor, including a first BWP and a second BWP.

FIG. 6 is a diagram illustrating an example NonCellDefiningSSB information element (IE).

FIG. 7 is a block diagram conceptually illustrating an example of a UE operating under the exception rule and communicating with a set of multiple serving cells.

FIG. 8 is a flowchart of a method of wireless communication.

FIG. 9 is a flowchart of a method of wireless communication.

FIG. 10 is a flowchart of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a diagram illustrating an example of a hardware implementation for an example apparatus.

FIG. 15 is a flowchart of a method of wireless communication.

FIG. 16 is a diagram illustrating another example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure.

One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

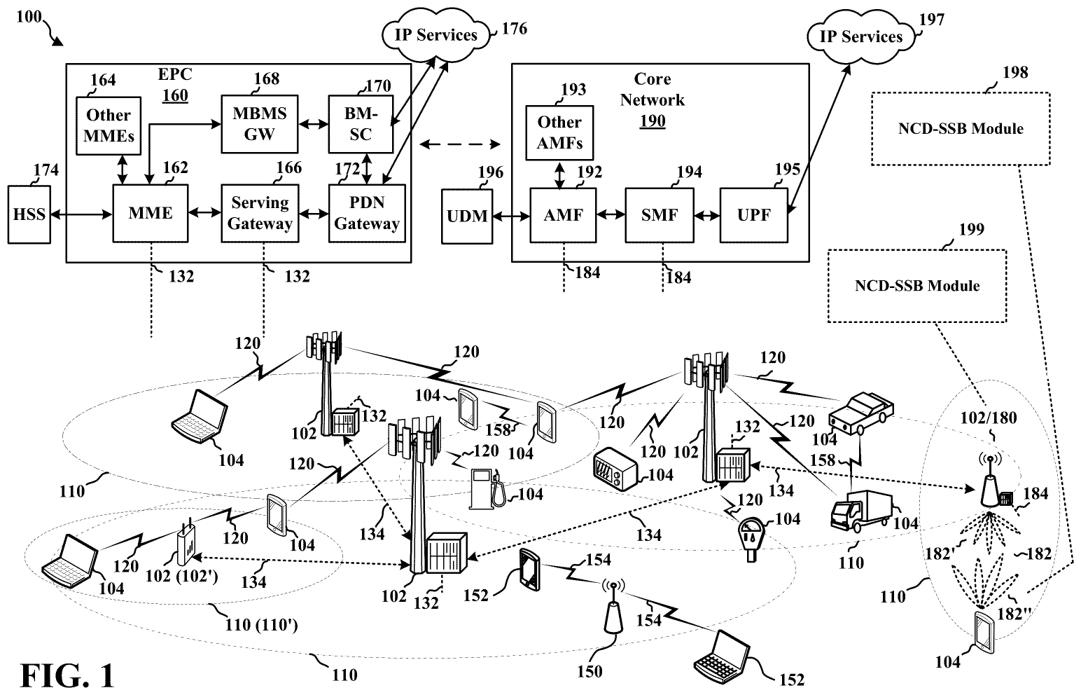

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QOS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A wireless node may comprise a UE, a base station, or a network entity of the base station.

Referring again to FIG. 1, the UE 104 may include an NCD-SSB module 198. As described in more detail elsewhere herein, the NCD-SSB module 198 may be configured to output for transmission an indication of whether the apparatus is capable of supporting half-duplex communications via time-division duplex (TDD) carrier aggregation (CA); and obtain a command configured to enable collision handling by the apparatus, the command being based on the capability supported by the apparatus. Additionally, or alternatively, the NCD-SSB module 198 may perform one or more other operations described herein.

The base station 102/180 may include an NCD-SSB module 199. As described in more detail elsewhere herein, the NCD-SSB module 199 may be configured to obtain, from a user equipment (UE), an indication of whether the UE is capable of supporting half-duplex communications via time-division duplex (TDD) carrier aggregation (CA); and output, for transmission to the UE, a command configured to enable collision handling at the UE, the command being output based on the capability supported by the UE. Additionally, or alternatively, the NCD-SSB module 199 may perform one or more other operations described herein.

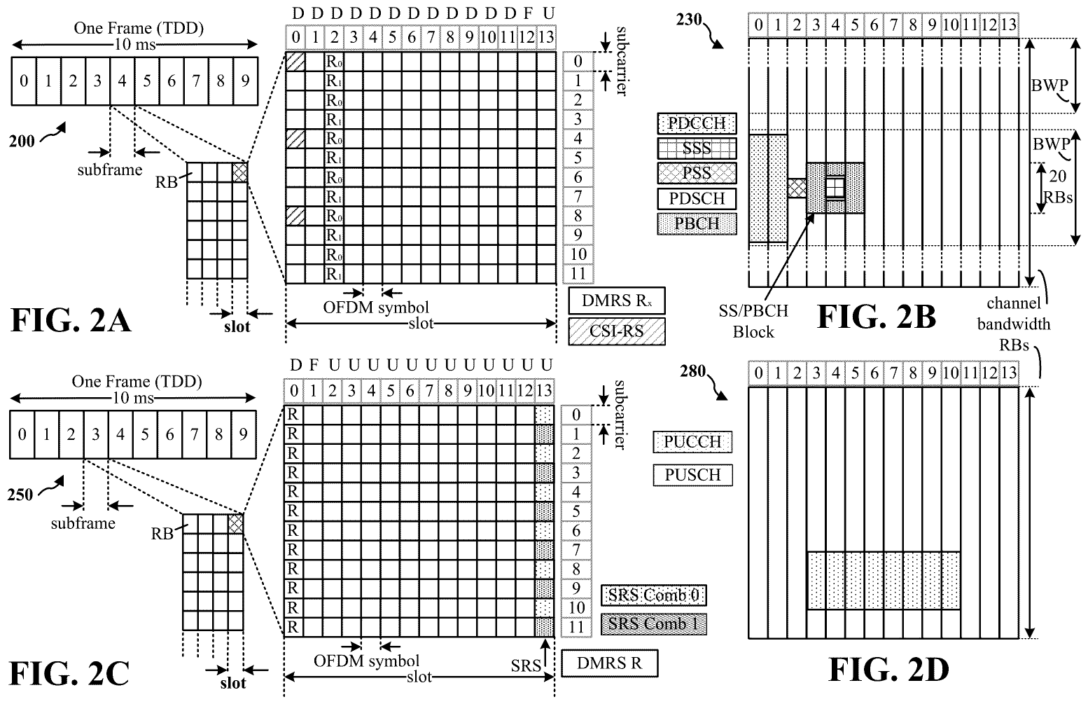

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 24 slots/subframe. The subcarrier spacing and symbol length/duration are a function of the numerology. The subcarrier spacing may be equal to 24*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

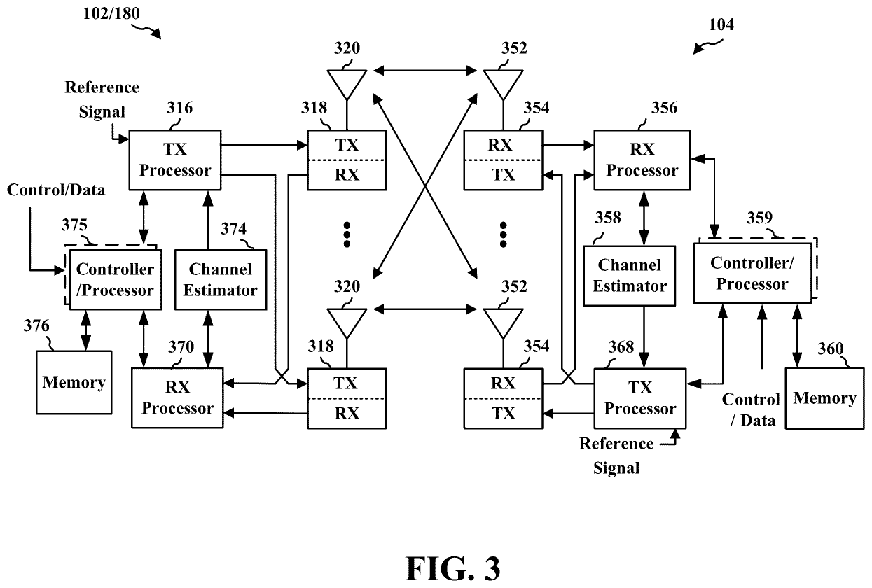

FIG. 3 is a block diagram of a base station 102/180 in communication with a UE 104 in an access network. In the DL, IP packets from the EPC 160 may be provided to one or more controller/processors 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 104. Each spatial stream may then be provided to a different antenna 320 via a separate transmitter 318TX. Each transmitter 318TX may modulate an RF carrier with a respective spatial stream for transmission.

At the UE 104, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 104. If multiple spatial streams are destined for the UE 104, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 102/180. These soft decisions may be based on channel estimates computed by the channel estimator 358. The soft decisions are then decoded and deinterleaved to recover the data and control signals that were originally transmitted by the base station 102/180 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 102/180, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization. Channel estimates derived by a channel estimator 358 from a reference signal or feedback transmitted by the base station 102/180 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 102/180 in a manner similar to that described in connection with the receiver function at the UE 104. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK and/or NACK protocol to support HARQ operations.

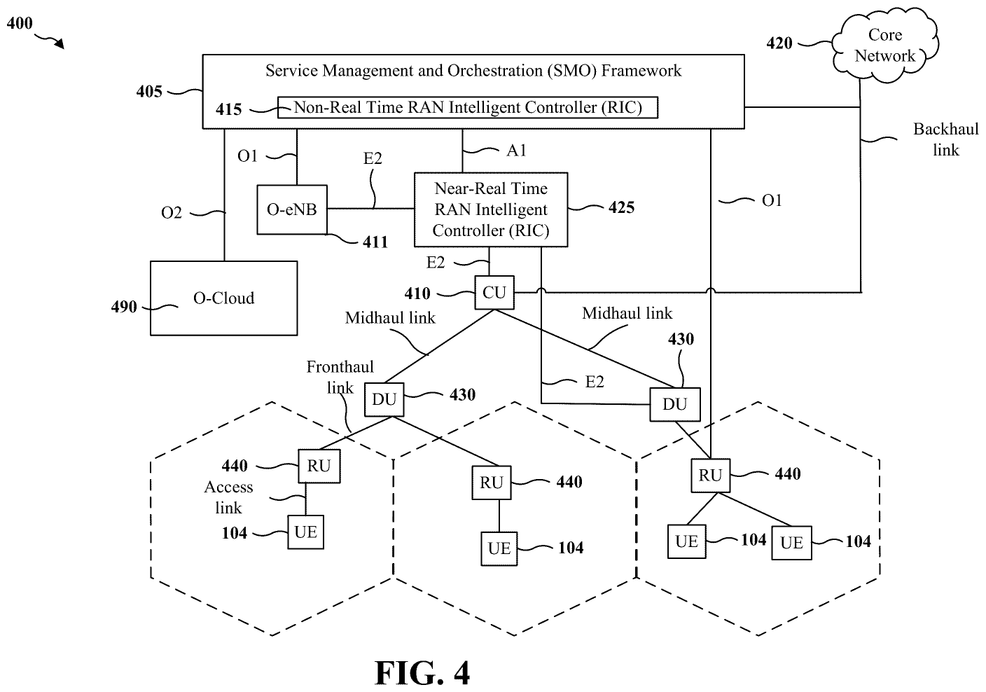

FIG. 4 is a block diagram illustrating an example disaggregated base station 400 architecture. The disaggregated base station 400 architecture may include one or more CUs 410 that can communicate directly with a core network 420 via a backhaul link, or indirectly with the core network 420 through one or more disaggregated base station units (such as a near real-time (RT) RIC 425 via an E2 link, or a non-RT RIC 415 associated with a service management and orchestration (SMO) Framework 405, or both). A CU 410 may communicate with one or more DUs 430 via respective midhaul links, such as an F1 interface. The DUs 430 may communicate with one or more RUs 440 via respective fronthaul links. The RUs 440 may communicate with respective UEs 104 via one or more radio frequency (RF) access links. In some implementations, the UE 104 may be simultaneously served by multiple RUs 440. As used herein, a network entity may correspond to a base station or to a disaggregated aspect (e.g., CU/DU/RU, etc.) of the base station.

Each of the units, i.e., the CUS 410, the DUs 430, the RUs 440, as well as the near-RT RICs 425, the non-RT RICs 415 and the SMO framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., central unit-user plane (CU-UP)), control plane functionality (i.e., central unit-control plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a virtual RAN (vRAN) architecture.

The SMO Framework 405 may be configured to support RAN deployment and provisioning of non-virtualized and virtualized network elements. For non-virtualized network elements, the SMO framework 405 may be configured to support the deployment of dedicated physical resources for RAN coverage requirements, which may be managed via an operations and maintenance interface (such as an O1 interface). For virtualized network elements, the SMO framework 405 may be configured to interact with a cloud computing platform (such as an open cloud (O-cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and near-RT RICs 425. In some implementations, the SMO framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO framework 405 also may include the non-RT RIC 415 configured to support functionality of the SMO Framework 405.

The non-RT RIC 415 may be configured to include a logical function that enables non-real-time control and optimization of RAN elements and resources, artificial intelligence/machine learning (AI/ML) workflows including model training and updates, or policy-based guidance of applications/features in the near-RT RIC 425. The non-RT RIC 415 may be coupled to or communicate with (such as via an A1 interface) the near-RT RIC 425. The near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the near-RT RIC 425.

In some implementations, to generate AI/ML models to be deployed in the near-RT RIC 425, the non-RT RIC 415 may receive parameters or external enrichment information from external servers. Such information may be utilized by the near-RT RIC 425 and may be received at the SMO Framework 405 or the non-RT RIC 415 from non-network data sources or from network functions. In some examples, the non-RT RIC 415 or the near-RT RIC 425 may be configured to tune RAN behavior or performance. For example, the non-RT RIC 415 may monitor long-term trends and patterns for performance and employ AI/ML models to perform corrective actions through the SMO Framework 405 (such as reconfiguration via 01) or via creation of RAN management policies (such as A1 policies).

### Introduction to Non-Cell Defining Synchronization Signal Block (NCD-SSB)

Non-cell defining SSB (NCD-SSB) was initially introduced for reduced capability (RedCap) user equipment (UE). As suggested by the name, the purpose of the NCD-SSB is not for identifying a particular cell, but rather to provide synchronization signaling to a UE for channel measurement, channel quality, beam management, etc. In contrast, a cell-defining SSB (CD-SSB) is configured to provide the UE with synchronization signaling and an indication of an identity of the cell from which it was transmitted. Thus, the NCD-SSB is an ideal synchronization signal for a RedCap UE that may not use cell identification information.

A base station may configure or schedule transmission of an NCD-SSB or CD-SSB for one or more dedicated downlink bandwidth parts (BWPs). For example, each BWP may include, at most, one SSB (e.g., either CD-SSB or NCD-SSB). Accordingly, a UE may be configured (e.g., by a base station and/or wireless standard) with two different BWPs to monitor: a first BWP and a second BWP.

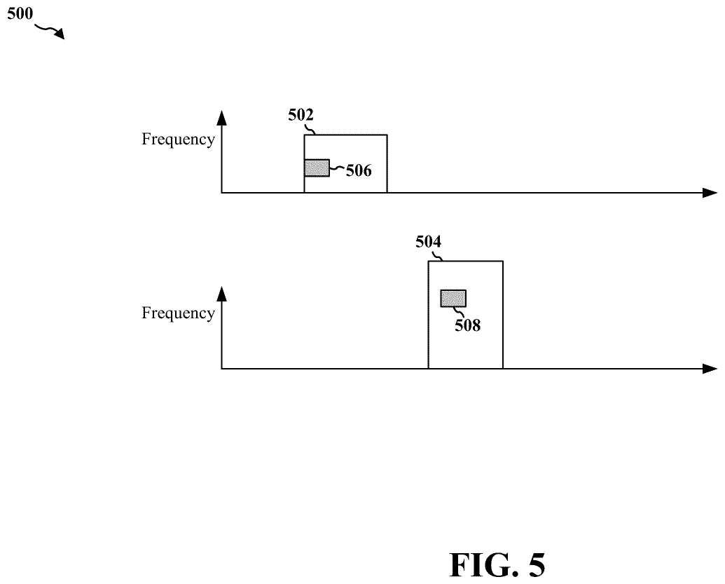

FIG. 5 is a block diagram conceptually illustrating an example set of BWPs 500 that a UE may be configured to monitor, including a first BWP 502 and a second BWP 504. Here, a CD-SSB 506 is transmitted by a cell within the first BWP 502, and an NCD-SSB 508 is transmitted by the cell within the second BWP 504. The UE may be configured for dynamic BWP activation, which allows the UE to activate either one of the BWPs. In some examples, the first BWP 502 and the second BWP 504 may be different BWPs of the same component carrier (CC).

As used herein, a “dedicated BWP” refers to a BWP that a UE has been configured (e.g., by a base station) to use, and it may be a UE-specific BWP (e.g., signaling dedicated to a particular UE). A “common BWP” relates to a cell-specific BWP for signaling that is not dedicated to a particular UE. An “initial BWP” relates to a BWP that the UE may use for initial access to a cell and may be advertised to the UE via a SIB or MIB. Typically, the initial BWP is configured such that it includes CD-SSB. An “active BWP” may relate to a BWP activated by a base station for the UE to monitor via radio resource control (RRC) configuration/reconfiguration, and may be configured to include CD-SSB and/or NCD-SSB.

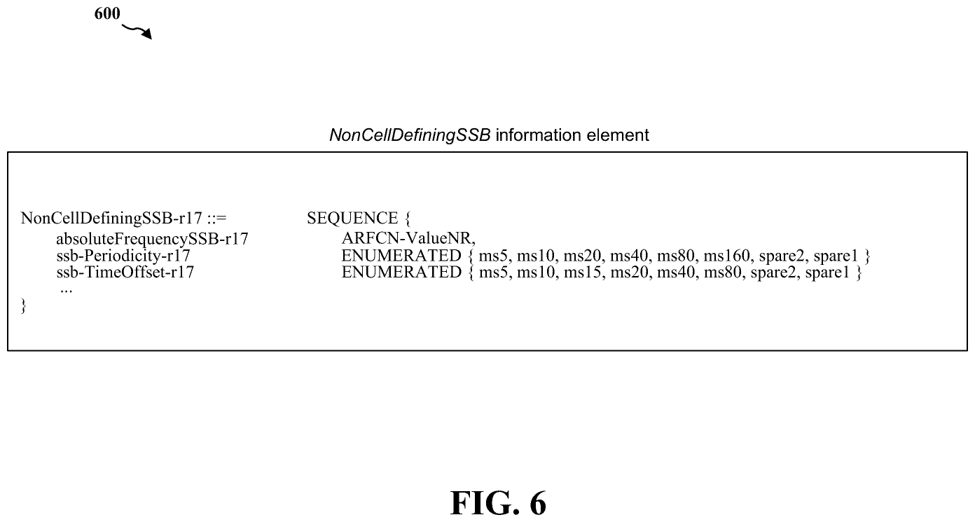

FIG. 6 is a diagram illustrating an example NonCellDefiningSSB information element (IE) 600 used to configure a UE to receive an NCD-SSB. A base station may transmit an RRC message containing the NonCellDefiningSSB IE 600 to a UE to configure the UE to monitor NCD-SSB in an initial BWP or a dedicated BWP. For example, the NonCellDefiningSSB IE 600 may be configured for each downlink BWP configuration (e.g., configured via BWP-DownlinkDedicated IE). In other words, the NonCellDefiningSSB IE 600 may be different for each BWP for which the UE is configured. If the NonCellDefiningSSB IE 600 is configured for a particular BWP, the UE may monitor the NCD-SSB instead of a CD-SSB.

The NonCellDefiningSSB IE 600 may include three primary components: an absolute radio frequency channel number (ARFCN) configured to provide a frequency-domain position of the NCD-SSB, a periodicity of the NCD-SSB, and a time-offset of the NCD-SSB. Referring back to FIG. 5, the NonCellDefiningSSB IE 600 may configure the UE to receive the NCD-SSB 508 of the second BWP 504 by providing ARFCN, periodicity, and offset information associated with the NCD-SSB 508.

In certain scenarios, a UE may be configured to with a capability for dynamic active BWP switching. That is, the UE may dynamically switch from one BWP to another by changing which BWP is active. In one example, the UE may be configured for dynamic BWP switching with restriction. In this case, the UE may dynamically switch active BWPs from multiple configured BWPs, where each of the multiple BWPs contain CD-SSB signaling within the corresponding bandwidths of the BWPs.

Alternatively, the UE may be configured for dynamic BWP switching without restriction. In this case, a UE can dynamically switch active BWP from multiple configured BWPs and any of the multiple BWPs can be configured such that it does not contain the CD-SSB within the bandwidth of the corresponding BWP. However, a problem arises because it is unclear how the UE should behave for channel measurement operations (e.g., beam management, radio link monitoring, beam failure recovery, beam failure detection, etc.) when CD-SSB is not transmitted within the UE's active BWP.

One solution for this problem involves allowing non-RedCap UEs to receive and use NCD-SSBs within active BWPs. Often called “Option C.” a base station or cell may configure a non-RedCap UE for dynamic BWP switching without restriction so long as the UE can receive and use NCD-SSBs within active BWPs that may not include a CD-SSB. As such, the non-RedCap UE may perform channel measurement operations based on NCD-SSB signals within an active BWP. Thus, a base station or cell may configure the UE for BWP switching without restriction so long as the BWPs used by the UE are configured by the base station or cell to include at least one of CD-SSB and/or NCD-SSB signaling.

### Introduction to Half-Duplex Operations for Inter-Band Time-Division Duplex (TDD) Carrier Aggregation (CA)

It should be noted that the Option C capability is a per-band capability. That is, if a UE declares support of Option C in a particular band, the UE should be capable of Option C communications on the band in any carrier aggregation (CA) band combinations that include the band. For example, a UE may transmit an indication of its support for Option C in a band of 3.5 GHz and its support for CA via a combination of 3.5 GHz and 4.5 GHz bands. In this case, if the UE and base station communicate via CA using a combination of 3.5 GHz and 4.5 GHz bands, the UE should be capable of using Option C in a band of 3.5 GHz with the CA using a combination of 3.5 GHZ and 4.5 GHz bands. Inter-band CA relates to a communication scenario where the CCs belong to different operating frequency bands. Some operator frequency allocation scenarios may require such communication.

For a UE using Option C for half-duplex communications made via inter-band time-division duplex (TDD) CA, the UE may indicate to a cell its support for half-duplex communications via TDD CA (e.g., half-DuplexTDD-CA-SameSCS-r16), and in response, the cell may configure the UE to perform collision handling at the UE (e.g., directionalCollisionHandling-r16 field is enabled) for multiple cells in CA. It should be noted that half-DuplexTDD-CA-SameSCS-r16 also indicates that the UE is not capable of transmitting via one CC and simultaneously receiving via another CC even if the two CCs are inter-band CCs. As such, an enabled directionalCollisionHandling-r16 enables the UE to handle potential collisions (e.g., downlink on a first CC and uplink on a second CC, both during the same symbol).

If the UE is not configured to monitor PDCCH for DCI (e.g., DCI format 2_0) on any of the multiple cells and the UE is not capable of simultaneous transmission and reception with the multiple cells (e.g., UE using half-duplex TDD CA), then the UE may select a reference cell for each symbol as an active cell by selecting the cell having a smallest cell index among the one or more cells. Based on the selected reference cell, the UE may perform handling of directional collision between CCs per symbol. This may be according to the example of Table 1 below.

TABLE 1

| No. | Ref Cell | Other Cell | UE Behavior |
|---|---|---|---|
| 1 | Semi SFI D | Semi SFI U | Allowed to drop U for inter-band |
| | | | Error case in intra-band |
| 2 | Semi SFI D | RRC U | Allowed to drop U |
| 3 | Semi SFI D | Dynamic U | Allowed to drop D for inter-band |
| | | | Error case for intra-band |
| 4 | Semi SFI U | Semi SFI D | Allowed to drop D for inter-band |
| | | | Error case for intra-band |
| 5 | Semi SFI U | RRC D | Allowed to drop D |
| 6 | Semi SFI U | Dynamic D | Error |
| 7 | RRC D | RRC U | Allowed to drop U |
| 8 | RRC U | RRC D | Allowed to drop D |
| 9 | Dynamic D | Dynamic U | Error |
| 10 | Dynamic U | Dynamic D | Error |
| 11 | RRC U | Semi SFI D | Allowed to drop D |
| 13 | RRC D | Semi SFI U | Allowed to drop U |
| 15 | RRC U | Dynamic D | Error |
| 16 | RRC D | Dynamic U | Allowed to drop D for inter-band |
| | | | Error case for intra-band |

The terms “Semi SFI D/U” is defined as a semi-static slot format indicator (SFI) for downlink (D) or uplink (U). The Semi SFI D/U may be designated by a cell or base station using higher-layer signaling (e.g., tdd-UL-DL-ConfigurationCommon or tdd-UL-DL-ConfigDedicated). The terms “RRC D/U” is defined as a semi-statically configured downlink/uplink for PDCCH, PDSCH, CSI-RS, PUCCH, PUSCH, SRS, and/or any other suitable signaling. The terms “Dynamic D/U” relate to downlink/uplink symbols corresponding to a dynamic grant. It should be noted that while the granularity of collision handling has been described in terms of symbols, any suitable level of granularity may also be used, including slots and frames.

Table 1 defines a set of directional collision rules that generally prioritize the reference cell. The Ref Cell column may correspond to a CC of a reference cell, and the Other Cell column may correspond to a CC of another cell. In row 1 (e.g., first rule), a reference cell may be a first CC (e.g., a CC having the smallest relative cell ID) configured with TDD downlink slot or symbol that overlaps in the time-domain (e.g., by one or more symbols) with an TDD uplink slot or symbol of a second CC identified as the other cell. The downlink symbols (e.g., semi SFI D) that overlap with the uplink symbols (semi SFI U) present a directional conflict for the UE because the UE cannot receive downlink signaling on the first CC and transmit uplink signaling on the second CC at the same time. Thus, according to table 1, the UE may prioritize the downlink signaling from the reference cell and drop the uplink transmission (e.g., drop the entire uplink slot or just the uplink symbols that overlap in the time-domain with the downlink slot). It should be noted that Table 1 is an example set of rules for directional collision management by a UE, and the UE may use any suitable set of rules and/or conditions for selecting a reference cell.

In some examples, a UE that is not capable of or configured for simultaneous transmission and reception with multiple cells (e.g., a UE operating in half-duplex mode) and is configured for directional collision handling, may receive a transmission (e.g., ssb-PositionsInBurst within ServingCellConfigCommonSIB) from a base station or one or more of the multiple cells identifying SSBs (and thereby the time-domain positions of the SSBs) that are being transmitted by a corresponding cell or base station. For example, a value of “0” in the bitmap indicates that a corresponding SSB will not be transmitted, while a value of “1” indicates that a corresponding other SSB will be transmitted. However, the directional collision rules may not account for SSBs transmitted by the multiple cells. Thus, the UE may handle SSBs independent of the directional collision rules.

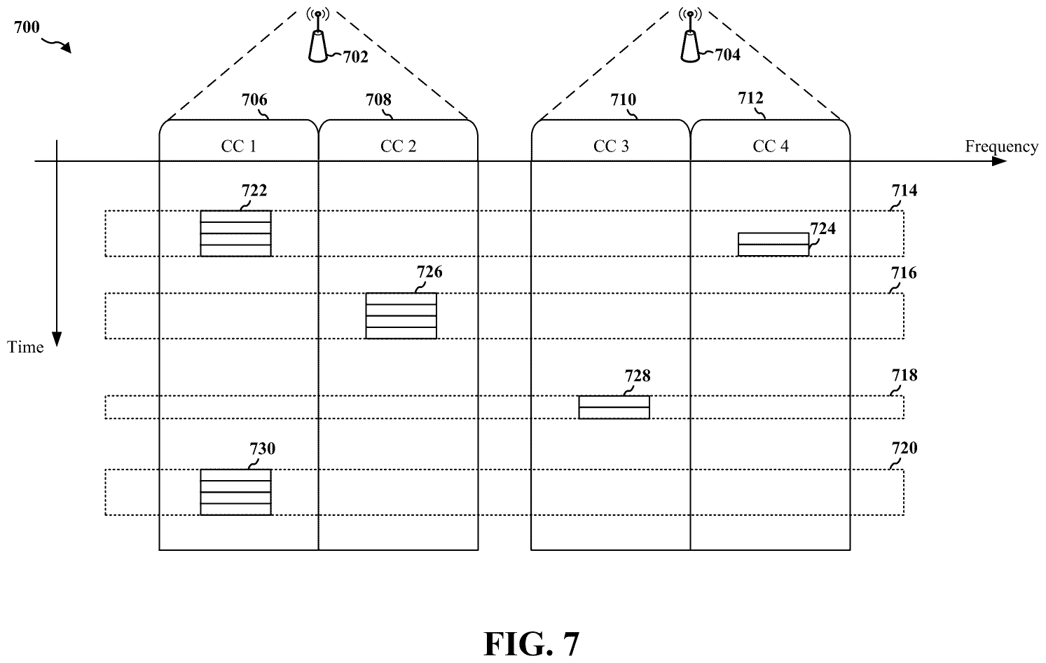

In one example, a UE that is configured to handle potential collisions, is configured for half-duplex CA (e.g., the UE indicates half-DuplexTDD-CA-SameSCS-r16), and is not configured to monitor PDCCH for DCI, may operate with an exception to one or more directional collision rules (e.g., FIG. 7). Here, for symbols where ssb-PositionsInBurst indicates that a first serving cell of the multiple serving cells is transmitting an SSB, the UE may prioritize reception of the SSB and drop an uplink transmission (e.g., PUSCH, PUCCH, PRACH, or SRS) via symbols that collide with the downlink SSB symbols. In other words, the UE may drop the uplink transmission for all of the multiple serving cells if any of the symbols used for the uplink transmission overlap with an SSB symbol.

FIG. 7 is a block diagram conceptually illustrating an example of a UE operating under the exception rule and communicating with a set of multiple serving cells. Here, a UE (e.g., UE 104 of FIGS. 1 and 3) is configured to communicate via a first serving cell (e.g., CC1 706), a second serving cell (e.g., CC2 708), a third serving cell (e.g., CC3 710), and a fourth serving cell (e.g., CC4 712) using half-duplex communications using inter-band TDD CA. The first serving cell and the second serving cell may both be discrete parts of a first base station 702 (e.g., base station 102 of FIGS. 1 and 3; disaggregated base station 400 of FIG. 4), and the third serving cell and the fourth serving cell may both be discrete parts of a second base station 704. Alternatively, each serving cell may be associated with a different base station or network entity. The UE may be assumed to be configured for inter-band TDD CA, configured for directional collision handling for the serving cells, support the half-DuplexTDD-CA-SameSCS-r16 capability, and not configured to monitor PDCCH for DCI from any of the serving cells.

In the example of FIG. 7, the UE may communicate with the first base station 702 via the first CC 706 and the second CC 708 of a 3.5 GHz operating band. The UE may also communicate with the second base station 704 via the third CC and the fourth CC of a 4.5 GHz operating band. In this example, because the two operating bands do not have enough of a frequency gap between them, the UE may not transmit to one of the base stations using the same time-domain resources (e.g., symbols, slots, etc.) to also receive signaling from the other base station. In other words, the UE may not be capable of transmitting to one cell and receiving from another cell simultaneously without significant interference or path loss. It should be noted that various reasons including environment, UE capabilities, etc., may prevent the UE from transmitting and receiving simultaneously. Although FIG. 7 only illustrates an example of a UE communicating with two base stations and four serving cells, the UE may communicate with any suitable number of base stations and cells, including more or fewer base stations and/or cells, using the same techniques and methods described herein.

Thus, if the UE is notified of one or more symbol(s) that will be used by each cell to transmit an SSB, the UE will not transmit an uplink communication (e.g., the UE may drop an uplink transmission) via any of the one or more symbol(s) of any of the CCs. Thus, the downlink SSB is given priority over uplink opportunities that share the same time-domain resources of the SSB.

The first base station 702 may configure (e.g., using a first ssb-PositionsInBurst) the UE with a first SSB 722 transmitted via the first CC 706, a second SSB 726 transmitted via the second CC 708, and a third SSB 730 transmitted via the first CC 706. Similarly, the second base station 704 may configure (e.g., using a second ssb-PositionsInBurst) the UE with a fourth SSB 724 via the third CC 710 and a fifth SSB 728 via the fourth CC 712.

Here, the first SSB 722 and the fourth SSB 724 overlap in the time-domain, with the first SSB 722 taking up more time-domain resources than the fourth SSB 724. Thus, the UE may refrain from transmitting any uplink communication to either serving cell using any CC during a first set 714 of time-domain resources. Here, the first set 714 of time-domain resources is primarily defined by the time-domain resources used for the first SSB 722.

The second SSB 726 uses time-domain resources in the second CC 708. Although no other CC is used for downlink SSB during this time, the UE may refrain from transmitting any uplink communication to either serving cell during a second set 716 of time-domain resources defined by the time-domain resources used for the second SSB 726.

The fifth SSB 728 uses time-domain resources in the third CC 710. Although no other CC is used for downlink SSB during this time, the UE may refrain from transmitting any uplink communication to either serving cell during a third set 718 of time-domain resources defined by the time-domain resources used for the fifth SSB 728.

Finally, the third SSB 730 uses time-domain resources in the first CC 706. Although no other CC is used for downlink SSB during this time, the UE may refrain from transmitting any uplink communication to either serving cell during a fourth set 720 of time-domain resources defined by the time-domain resources used for the third SSB 730.

Accordingly, rules for downlink SSB communications may be an exception to one of more of the rules described above in connection with Table 1, as the UE may prioritize SSB reception over uplink transmission by dropping uplink transmission that use the same time-domain resources as an SSB. As such, the UE may perform channel measurement operations using the received SSBs and reduce interference or path loss cause by simultaneous downlink reception and uplink transmission.

It should be noted that the UE may perform the exception SSB handling illustrated in FIG. 7 as an extension of its directional collision handling process. For example, the UE may: (1) identify UL prohibited resources of all the cells based on ssb-PositionsInBurst of all the relevant cells and CCs, and then (2) perform the directional collision handling described in connection with FIG. 5 based on which cell is the reference cell. The first process (1) may not depend on which serving cell is active/inactive or which downlink BWP of each CC is active/inactive. Thus, the UE may not be required to perform the first process of identifying UL prohibited resources again if an active BWP of a CC changes or if a another serving cell (e.g., another CC) becomes active.

However, the UE may be required to perform one or more of the first process (1) and the second process (2) every time the UE's active BWP of a CC is changed. For example, if the UE is configured for Option C for a CC, then the UE may receive the NCD-SSB configuration with each dedicated downlink BWP configuration for the CC. The NCD-SSB configuration may be different for different dedicated downlink BWP configurations of the CC. Thus, depending on which BWP of the CC is active, NCD-SSB locations (e.g., periodicity and/or offset) may change, causing the UE to re-perform the first process of identifying UL prohibited resources of all the cells based on ssb-PositionsInBurst. Moreover, the UE may be required to perform the second process of determining directional collision handling every time the UE changes its active BWP because the rules (for example, those shown in FIG. 7) controlling UE behavior may change according to which BWP is active for each serving cell. Accordingly, the UE may be required to spend a relatively significant amount of time performing processes (1) and (2) every time the UE switches an active BWP for any of the multiple cells it communicates with.

Example Techniques for Reducing Processing Time Associated with the First Process and the Second Process

The following are solutions for reducing the number of instances that a UE has to perform either of the first process (1) and/or the second process (2) described above. For the following aspects, the UE may be assumed to be configured with half-duplex inter-band TDD CA with directionalCollisionHandling-r16 enabled.

In certain aspects, based on collision handling being performed by the UE, the UE may not expect to be configured for dynamic active BWP switching without restriction and/or Option C. In other words, if the UE supports half-DuplexTDD-CA-SameSCS-r16 and is configured by the network to perform directional collision handling, then the network may restrict the UEs use of NCD-SSB for Option C. In one example, the network may configure the UE for dynamic active BWP switching with restriction so that the UE uses CD-SSBs for channel measurements instead of NCD-SSBs. The network may instead configure the UE for one of Option A, Option B-1-1, or Option B-1-2, if necessary. Accordingly, the UE may not be required to re-perform the first process or the second process upon switching an active BWP for any of the multiple serving cells because the CD-SSB locations are known to the UE. In certain aspects, the network may restrict transmission of NCD-SSBs to the same time-domain resources, or a subset of the same time domain resources, used to transmit CD-SSBs. It should be noted, the ssb-PositionsInBurst from each serving cell provides the UE with the location of CD-SSBs for each CC used by the corresponding serving cell. Thus, while each of the multiple serving cells may transmit NCD-SSBs via any one or more corresponding CCs, the network may limit transmissions of NCD-SSB to the time-domain resources used by CD-SSBs. For example, if CD-SSB periodicity is 20 ms for one or more serving cells, then NCD-SSBs transmitted for any active BWP of any of the multiple serving cells may have a periodicity of 20 ms, 40 ms, 80 ms, or 160 ms, and/or with offset of Oms, 20 ms, 40 ms, or 80 ms. Although NCD-SSB locations may be different across different BWPs for any of the multiple serving cells, the UE may not have to re-do the first process to identify uplink prohibited resources because all the NCD-SSB locations are within known uplink prohibited resources identified by CD-SSB of the serving cells.

In certain aspects, if the UE switches its active BWP from a first BWP to a second BWP for a first serving cell, and the second BWP uses NCD-SSBs, then the UE may expect that every NCD-SSB symbol of the first serving cell is also a downlink symbol of a reference cell. For example, NCD-SSB symbols used in one CC by one serving cell may be the same symbols used by another CC and/or another service cell for downlink transmission. In some examples, the downlink transmission symbols are configured according to tdd-UL-DL-ConfigurationCommon or tdd-UL-DL-ConfigurationDedicated for a reference cell. This is because according to the example rules shown in Table 1 above, the downlink symbols of the reference cell may generally have priority over cells, and thus if the NCD-SSB symbols are transmitted using the same symbols used by the downlink symbols of the reference cell, the UE may receive the NCD-SSB and be prevented from transmitting on an uplink symbol associated with another cell during the downlink symbols of the reference cell.

In certain aspects, a reference cell may be configured to transmit NCD-SSB during its downlink symbols (e.g., downlink symbols configured via tdd-UL-DL-ConfigurationCommon or tdd-UL-DL-ConfigurationDedicated). As such, because TDD downlink slot or symbols of the reference cell has top priority according to Table 1 above, the UE will favor the downlink symbols of the reference cell over the same symbols of another cell(s). Thus, in the second process, the UE may always receive the NCD-SSB from the reference cell because the NCD-SSB will have priority over symbols of other cells. In some examples, the UE may not take NCD-SSBs into account when it performs the first process (e.g., the UE may only take into account CD-SSB). Therefore, the NCD-SSBs transmitted by cells other than the reference cells may be dropped or ignored by the UE if other cell's NCD-SSB symbols are colliding with TDD uplink slots or symbols of the reference cell.

In some examples, the UE may take NCD-SSB locations into account for the second process and treat NCD-SSB locations as “RRC D” (e.g., RRC downlink) which has lower priority relative to downlink symbols configured via tdd-UL-DL-ConfigurationCommon or tdd-UL-DL-ConfigurationDedicated. Thus, in this example, the UE may have more opportunity to drop NCD-SSB signals in cases of directional collision. Again, if the reference cell is transmitting the NCD-SSB, then it may have higher priority relative to another cell(s). In the other cell(s), or in the reference cell when NCD-SSB overlaps with a dynamic U of the other cell(s), the NCD-SSB may be dropped.

In certain aspects, the UE may be configured to take into account NCD-SSB in its active downlink BWP for the first process (e.g., the UE may identify uplink prohibited resources of the cells based on ssb-PositionsInBurst). Because the UE may need to perform the first process each time it changes the active BWP, the UE may be configured with a relatively longer switching delay configured to provide the UE with extra time to perform the first process. For example, if the UE switches its active BWP from a first BWP to a second BWP, but does not have to take into account NCD-SSB (e.g., the UE does not have to perform the first process), then the UE may use a first switching delay. However, if the UE switches its active BWP from a third BWP to a fourth BWP, and has to take into account NCD-SSB (e.g., the UE may perform the first process to determine uplink prohibited resources), then the UE may use a second switching delay that has a longer duration relative to the first switching delay. As used herein, a “non-legacy switching delay” or “second switching delay” is defined by the switching delay provided by Third Generation Partnership Project (3GPP) Release 18 wireless standards and future releases. The “legacy switching delay” or “first switching delay” may correspond to a switching delay as defined by Release 17 and earlier 3GPP standards.

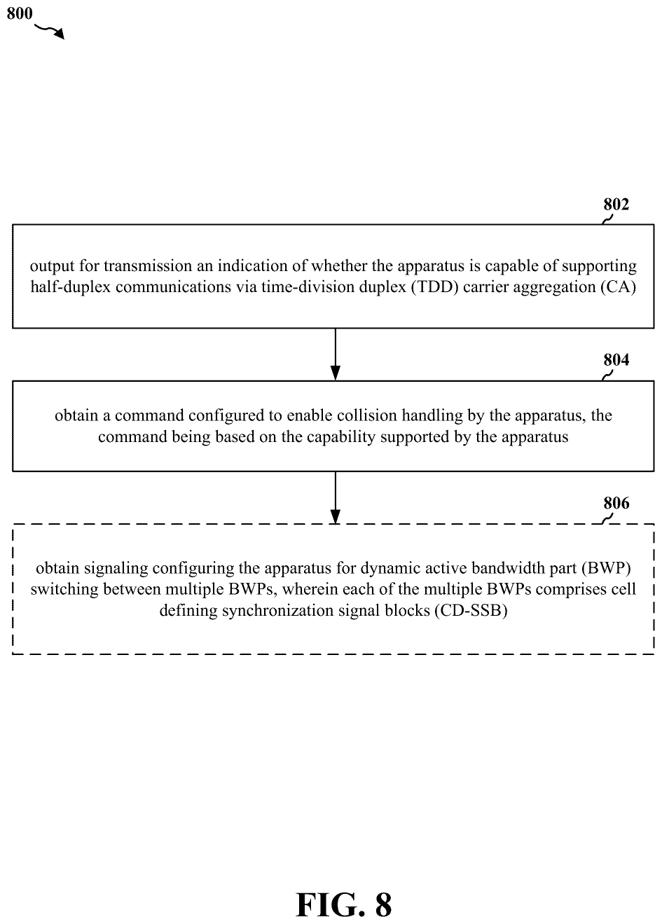

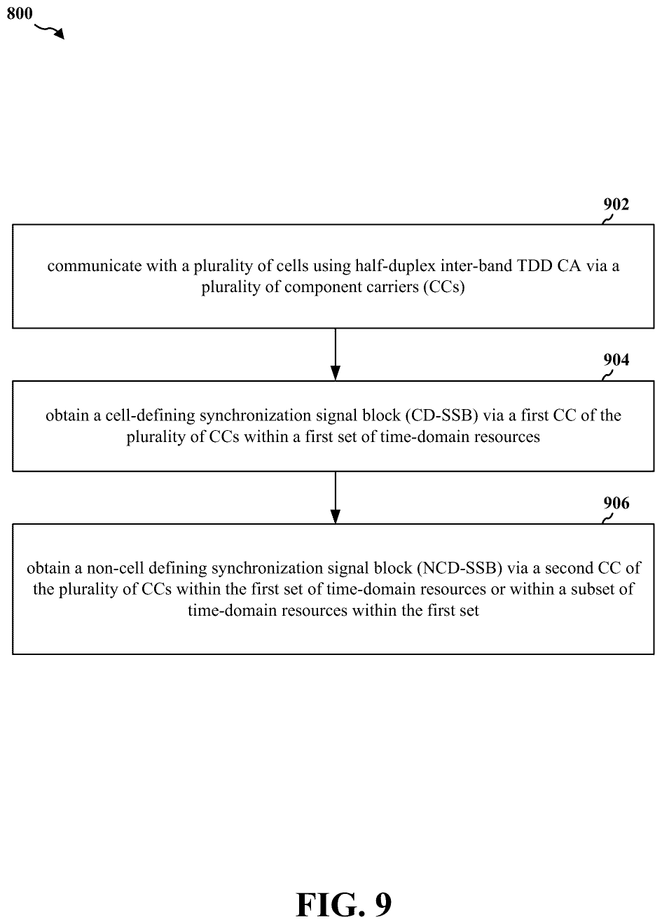

FIG. 8 is a flowchart of a method 800 of wireless communication. The method 800 may be performed by a UE (e.g., the UE 104; the apparatus 1402). In some examples, the method 800 may include one or more aspects illustrated and described in connection with FIGS. 9-13. The method 800 may be performed by one or more processors (e.g., controller/processor 359, RX processor 356, TX processor 368, memory 360 in FIG. 3, etc.).

At 802, the UE may output for transmission an indication of whether the apparatus is capable of supporting half-duplex communications via time-division duplex (TDD) carrier aggregation (CA). For example, 802 may be performed by a transmitting component 1440. Here, the UE may transmit its capabilities to a base station or network entity so that the base station can adjust how it communicates with the UE. For example, the UE may indicate its support for half-DuplexTDD-CA-SameSCS-r16 capability. In certain aspects, the capability for half-duplex communications is associated with inter-band TDD CA.

At 804, the UE may obtain a command configured to enable collision handling by the apparatus, the command being based on the capability supported by the apparatus. For example, 804 may be performed by a receiving component 1442. Here, the base station or network node may configure the UE for directional collision handling (e.g., directionalCollisionHandling-r16=enabled) for a set of cells in CA. The base station may configure the UE for directional collision handling based on the UE communication at 802.

At 806, the UE may optionally obtain signaling configuring the apparatus for dynamic active bandwidth part (BWP) switching between multiple BWPs, wherein each of the multiple BWPs comprises cell defining synchronization signal blocks (CD-SSB). For example, 806 may be performed by the receiving component 1442. Here, the base station may configure the UE so that it can dynamically switch active BWPs among a plurality of BWPs. In some examples, each of the plurality of BWPs includes a CD-SSB. In some examples, one or more of the plurality of BWPs includes an NCD-SSB instead of a CD-SSB. In other words, at 806, the base station may refrain from configuring the UE to use BWPs that contain NCD-SSBs if directionalCollisionHandling-r16=enabled.

FIG. 9 is a flowchart showing the method 800 of wireless communication including aspects in addition and/or in the alternative of those shown in FIGS. 8 and 10-13. In connection with these aspects, the network may not transmit NCD-SSBs outside of time resources used by CD-SSB. For example, NCD-SSBs may be transmitted using CD-SSB time resources but may not be transmitted outside those time resources.

At 902, the UE may communicate with a plurality of cells using half-duplex inter-band TDD CA via a plurality of component carriers (CCs). For example, 902 may be performed by the transmitting component 1440 and the receiving component 1442. Here, the UE may transmit and receive signaling from multiple base stations via multiple CCs using half-duplex TDD CA. If the UE is configured for directional collision handling, then the UE may identify prohibited resources of all the CCs based on ssb-PositionsInBurst (e.g., first process).

At 904, the UE may obtain a cell-defining synchronization signal block (CD-SSB) via a first CC of the plurality of CCs within a first set of time-domain resources. For example, 904 may be performed by the receiving component 1442.

At 906, the UE may obtain a non-cell defining synchronization signal block (NCD-SSB) via a second CC of the plurality of CCs within the first set of time-domain resources or within a subset of time-domain resources within the first set. For example, 906 may be performed by the receiving component 1442.

In certain aspects, the NCD-SSB is obtained via a downlink bandwidth part (BWP) of the second CC.

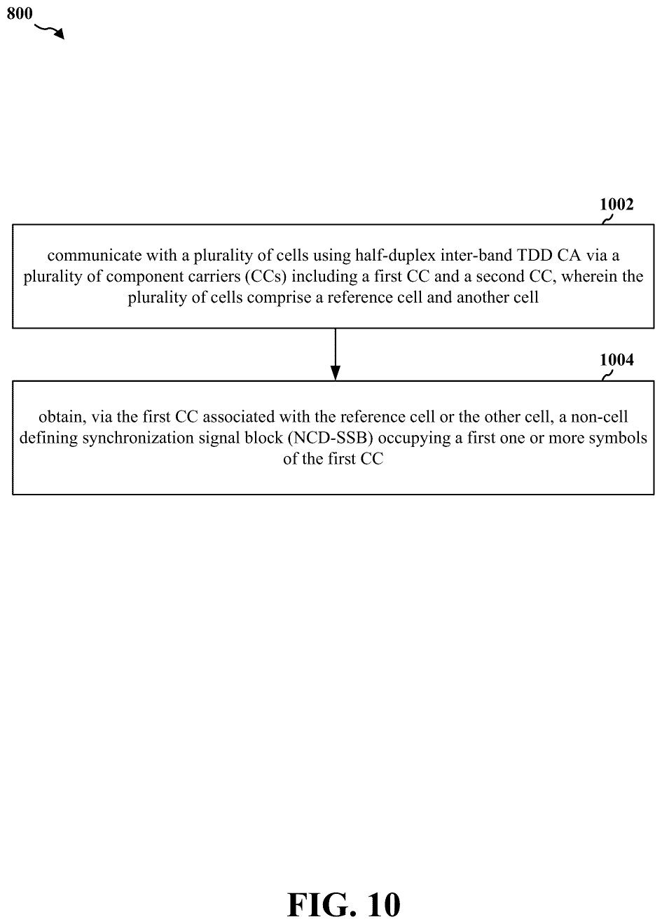

FIG. 10 is a flowchart showing the method 800 of wireless communication including aspects in addition and/or in the alternative of those shown in FIGS. 8, 9 and 11-13. In connection with these aspects, NCD-SSB resources of any CC are semi-static downlink symbols of a reference cell.

At 1002, the UE may communicate with a plurality of cells using half-duplex inter-band TDD CA via a plurality of component carriers (CCs) including a first CC and a second CC, wherein the plurality of cells comprise a reference cell and another cell. For example, 1002 may be performed by the transmitting component 1440 and the receiving component 1442.

At 1004, the UE may obtain, via the first CC associated with the reference cell or the other cell, a non-cell defining synchronization signal block (NCD-SSB) occupying a first one or more symbols of the first CC. For example, 1004 may be performed by the receiving component 1442.

In certain aspects, the first CC is associated with the reference cell, and the first one or more symbols are configured as at least one of semi-static downlink symbols or radio resource configuration (RRC) downlink symbols.

In certain aspects, the first CC is associated with the other cell and the second CC is associated with the reference cell, and the first one or more symbols of the second CC are configured as at least one of semi-static downlink symbols or radio resource configuration (RRC) downlink symbols.

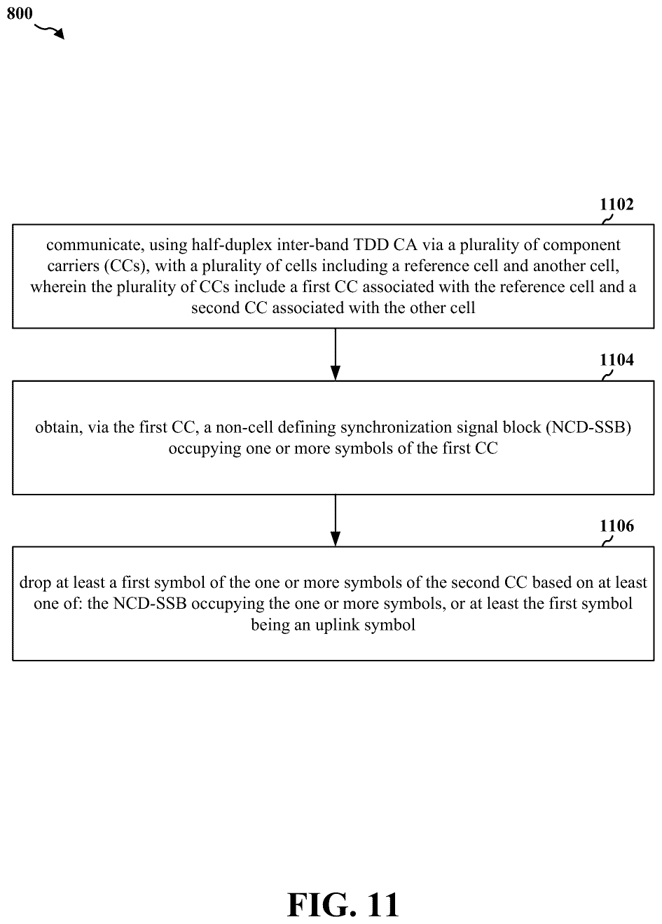

FIG. 11 is a flowchart showing the method 800 of wireless communication including aspects in addition and/or in the alternative of those shown in FIGS. 8-10, 12, and 13. In connection with these aspects, NCD-SSB has top priority when transmitted by a reference cell.

At 1102, the UE may communicate, using half-duplex inter-band TDD CA via a plurality of component carriers (CCs), with a plurality of cells including a reference cell and another cell, wherein the plurality of CCs include a first CC associated with the reference cell and a second CC associated with the other cell. For example, 1102 may be performed by the transmitting component 1440 and the receiving component 1442.

At 1104, the UE may obtain, via the first CC, a non-cell defining synchronization signal block (NCD-SSB) occupying one or more symbols of the first CC. For example, 1104 may be performed by the receiving component 1442.

At 1106, the UE may drop at least a first symbol of the one or more symbols of the second CC based on at least one of: the NCD-SSB occupying the one or more symbols, or at least the first symbol being an uplink symbol. For example, 1106 may be performed by a signal processing component 1444. As used herein, dropping a symbol may relate to a UE that does not monitor or receive that symbol. In some examples, a UE may drop a symbol by refraining from transmitting via that symbol.

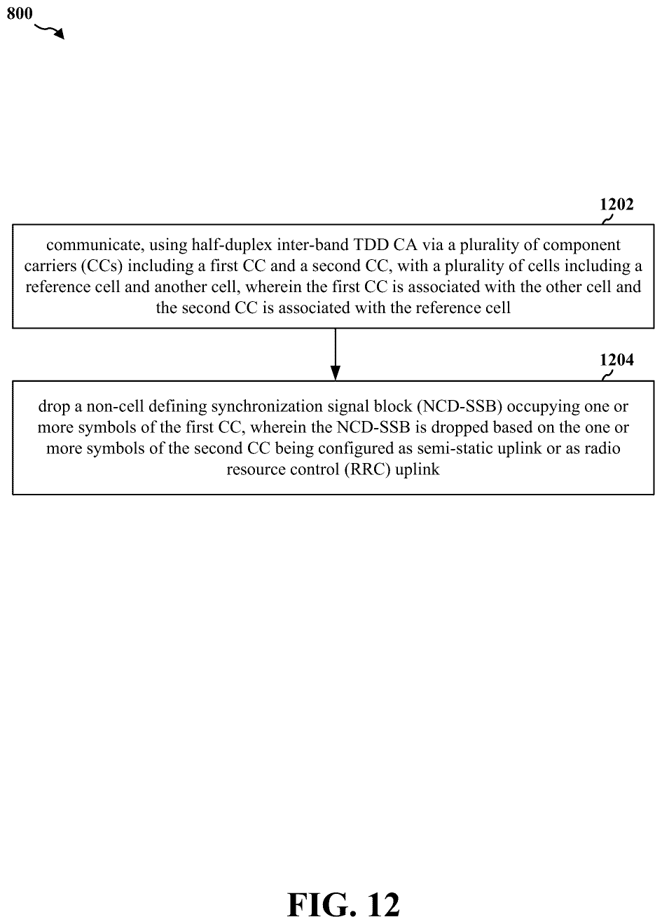

FIG. 12 is a flowchart showing the method 800 of wireless communication including aspects in addition and/or in the alternative of those shown in FIGS. 8-11 and 13. In connection with these aspects, the UE may be configured with a longer switching delay.

At 1202, the UE may communicate, using half-duplex inter-band TDD CA via a plurality of component carriers (CCs) including a first CC and a second CC, with a plurality of cells including a reference cell and another cell, wherein the first CC is associated with the other cell and the second CC is associated with the reference cell. For example, 1202 may be performed by the transmitting component 1440 and the receiving component 1442.

At 1204, the UE may drop a non-cell defining synchronization signal block (NCD-SSB) occupying one or more symbols of the first CC, wherein the NCD-SSB is dropped based on the one or more symbols of the second CC being configured as semi-static uplink or as radio resource control (RRC) uplink. For example, 1214 may be performed by the signal processing component 1444. In certain aspects, the NCD-SSB may be dropped based further on the second CC being associated with the reference cell and the reference cell having priority over the other cell (e.g., non-reference cell).

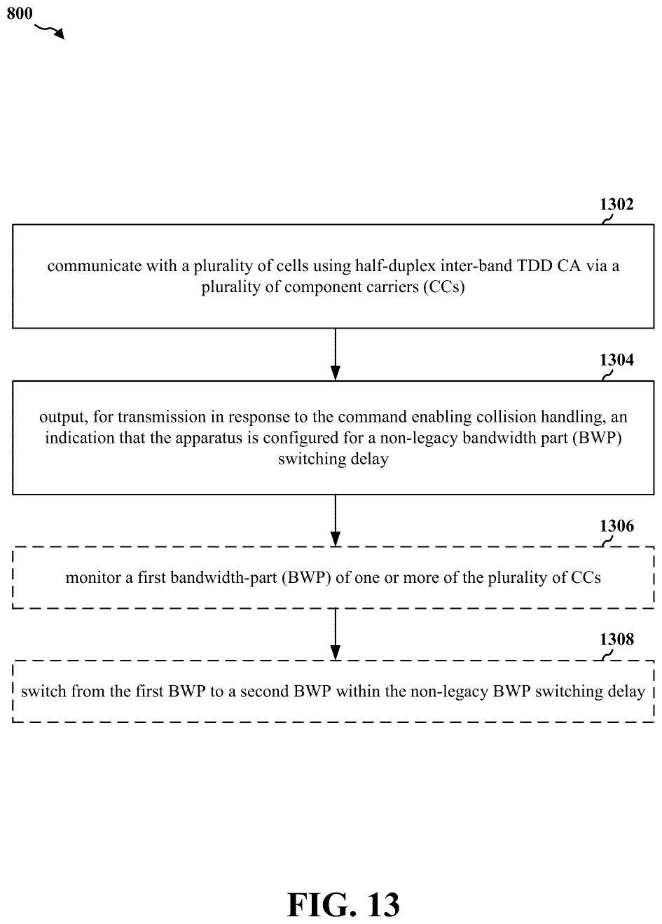

FIG. 13 is a flowchart showing the method 800 of wireless communication including aspects in addition and/or in the alternative of those shown in FIGS. 8-12. In connection with these aspects, For example, if a UE switches its active BWP from a first BWP to a second BWP, but does not have to take into account NCD-SSB (e.g., the UE does not have to perform the first process), then the UE may use a first switching delay. However, if the UE switches its active BWP from a third BWP to a fourth BWP, and has to take into account NCD-SSB of the fourth BWP (e.g., the UE may perform the first process to determine uplink prohibited resources), then the UE may use a second switching delay that has a longer duration relative to the first switching delay to perform the first process.

At 1302, the UE may communicate with a plurality of cells using half-duplex inter-band TDD CA via a plurality of component carriers (CCs). For example, 1302 may be performed by the transmitting component 1440 and the receiving component 1442.

At 1304, the UE may output, for transmission in response to the command enabling collision handling, an indication that the apparatus is configured for a non-legacy bandwidth part (BWP) switching delay. For example, 1304 may be performed by the transmitting component 1440.

At 1306, the UE may optionally monitor a first bandwidth-part (BWP) of one or more of the plurality of CCs. For example, 1306 may be performed by a monitoring component 1446.

At 1308, the UE may optionally switch from the first BWP to a second BWP within the non-legacy BWP switching delay. For example, 1308 may be performed by a switching component 1448. The non-legacy BWP switching delay may be a longer duration than the non-legacy switching delay in order to accommodate the UE performing the first process (e.g., identify prohibited resources based on ssb-PositionsInBurst). Thus, the non-legacy BWP switching delay may have a longer duration relative to a legacy BWP switching delay.

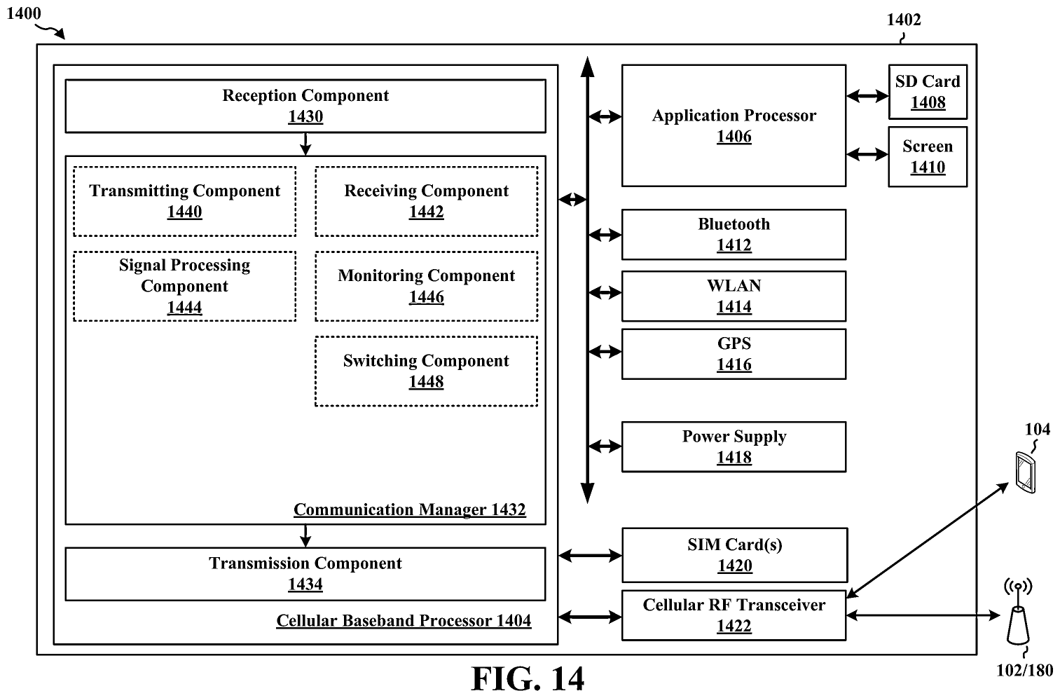

FIG. 14 is a diagram 1400 illustrating an example of a hardware implementation for an apparatus 1402. The apparatus 1402 is a UE and includes a cellular baseband processor 1404 (also referred to as a modem) coupled to a cellular RF transceiver 1422 and one or more subscriber identity modules (SIM) cards 1420, an application processor 1406 coupled to a secure digital (SD) card 1408 and a screen 1410, a Bluetooth module 1412, a wireless local area network (WLAN) module 1414, a Global Positioning System (GPS) module 1416, and a power supply 1418. The cellular baseband processor 1404 communicates through the cellular RF transceiver 1422 with the UE 104 and/or BS 102/180. The cellular baseband processor 1404 may include a computer-readable medium/memory. The computer-readable medium/memory may be non-transitory. The cellular baseband processor 1404 is responsible for general processing, including the execution of software stored on the computer-readable medium/memory. The software, when executed by the cellular baseband processor 1404, causes the cellular baseband processor 1404 to perform the various functions described supra. The computer-readable medium/memory may also be used for storing data that is manipulated by the cellular baseband processor 1404 when executing software. The cellular baseband processor 1404 further includes a reception component 1430, a communication manager 1432, and a transmission component 1434. The communication manager 1432 includes the one or more illustrated components. The components within the communication manager 1432 may be stored in the computer-readable medium/memory and/or configured as hardware within the cellular baseband processor 1404. The cellular baseband processor 1404 may be a component of the UE 104 and may include the memory 360 and/or at least one of the TX processor 368, the RX processor 356, and the controller/processor 359. In one configuration, the apparatus 1402 may be a modem chip and include just the baseband processor 1404, and in another configuration, the apparatus 1402 may be the entire UE (e.g., see UE 104 of FIG. 3) and include the aforediscussed additional modules of the apparatus 1402. In various examples, the apparatus 1402 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 1432 includes a transmitting component 1440 that is configured to output for transmission an indication of whether the apparatus is capable of supporting half-duplex communications via time-division duplex (TDD) carrier aggregation (CA); communicate with a plurality of cells using half-duplex inter-band TDD CA via a plurality of component carriers (CCs); communicate with a plurality of cells using half-duplex inter-band TDD CA via a plurality of component carriers (CCs) including a first CC and a second CC, wherein the plurality of cells comprise a reference cell and another cell; communicate, using half-duplex inter-band TDD CA via a plurality of component carriers (CCs), with a plurality of cells including a reference cell and another cell, wherein the plurality of CCs include a first CC associated with the reference cell and a second CC associated with the other cell; communicate, using half-duplex inter-band TDD CA via a plurality of component carriers (CCs) including a first CC and a second CC, with a plurality of cells including a reference cell and another cell, wherein the first CC is associated with the other cell and the second CC is associated with the reference cell; communicate with a plurality of cells using half-duplex inter-band TDD CA via a plurality of component carriers (CCs); and output, for transmission in response to the command enabling collision handling, an indication that the apparatus is configured for a non-legacy bandwidth part (BWP) switching delay; e.g., as described in connection with 802, 902, 1002, 1102, 1202, 1302, and 1304.

The communication manager 1432 further includes a receiving component 1442 configured to obtain a command configured to enable collision handling by the apparatus, the command being based on the capability supported by the apparatus; obtain signaling configuring the apparatus for dynamic active bandwidth part (BWP) switching between multiple BWPs, wherein each of the multiple BWPs comprises cell defining synchronization signal blocks (CD-SSB); communicate with a plurality of cells using half-duplex inter-band TDD CA via a plurality of component carriers (CCs); obtain a cell-defining synchronization signal block (CD-SSB) via a first CC of the plurality of CCs within a first set of time-domain resources; obtain a non-cell defining synchronization signal block (NCD-SSB) via a second CC of the plurality of CCs within the first set of time-domain resources or within a subset of time-domain resources within the first set; communicate with a plurality of cells using half-duplex inter-band TDD CA via a plurality of component carriers (CCs) including a first CC and a second CC, wherein the plurality of cells comprise a reference cell and another cell; obtain, via the first CC associated with the reference cell or the other cell, a non-cell defining synchronization signal block (NCD-SSB) occupying a first one or more symbols of the first CC; communicate, using half-duplex inter-band TDD CA via a plurality of component carriers (CCs), with a plurality of cells including a reference cell and another cell, wherein the plurality of CCs include a first CC associated with the reference cell and a second CC associated with the other cell; obtain, via the first CC, a non-cell defining synchronization signal block (NCD-SSB) occupying one or more symbols of the first CC; communicate, using half-duplex inter-band TDD CA via a plurality of component carriers (CCs) including a first CC and a second CC, with a plurality of cells including a reference cell and another cell, wherein the first CC is associated with the other cell and the second CC is associated with the reference cell; and communicate with a plurality of cells using half-duplex inter-band TDD CA via a plurality of component carriers (CCs), e.g., as described in connection with 804, 806, 902, 904, 906, 1002, 1004, 1102, 1104, 1202, 1302, and 1304.

The communication manager 1432 further includes a signal processing component 1444 configured to drop at least a first symbol of the one or more symbols of the second CC based on at least one of: the NCD-SSB occupying the one or more symbols, or at least the first symbol being an uplink symbol; and drop a non-cell defining synchronization signal block (NCD-SSB) occupying one or more symbols of the first CC, wherein the NCD-SSB is dropped based on the one or more symbols of the second CC being configured as semi-static uplink or as radio resource control (RRC) uplink, e.g., as described in connection with 1106 and 1204.

The communication manager 1432 further includes a monitoring component 1446 configured to monitor a first bandwidth-part (BWP) of one or more of the plurality of CCs, e.g., as described in connection with 1306.

The communication manager 1432 further includes a switching component 1448 configured to switch from the first BWP to a second BWP within the non-legacy BWP switching delay, e.g., as described in connection with 1308.

The apparatus may include additional components that perform each of the blocks of the algorithm in the aforementioned flowcharts of FIGS. 8-13. As such, each block in the aforementioned flowcharts of FIGS. 8-13 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1402, and in particular the cellular baseband processor 1404, includes means for outputting for transmission an indication of whether the apparatus is capable of supporting half-duplex communications via time-division duplex (TDD) carrier aggregation (CA); means for obtaining a command configured to enable collision handling by the apparatus, the command being based on the capability supported by the apparatus; means for obtaining signaling configuring the apparatus for dynamic active bandwidth part (BWP) switching between multiple BWPs, wherein each of the multiple BWPs comprises cell defining synchronization signal blocks (CD-SSB); means for communicating with a plurality of cells using half-duplex inter-band TDD CA via a plurality of component carriers (CCs); means for obtaining a cell-defining synchronization signal block (CD-SSB) via a first CC of the plurality of CCs within a first set of time-domain resources; means for obtaining a non-cell defining synchronization signal block (NCD-SSB) via a second CC of the plurality of CCs within the first set of time-domain resources or within a subset of time-domain resources within the first set; means for communicating with a plurality of cells using half-duplex inter-band TDD CA via a plurality of component carriers (CCs) including a first CC and a second CC, wherein the plurality of cells comprise a reference cell and another cell; means for obtaining, via the first CC associated with the reference cell or the other cell, a non-cell defining synchronization signal block (NCD-SSB) occupying a first one or more symbols of the first CC; means for communicating, using half-duplex inter-band TDD CA via a plurality of component carriers (CCs), with a plurality of cells including a reference cell and another cell, wherein the plurality of CCs include a first CC associated with the reference cell and a second CC associated with the other cell; means for obtaining, via the first CC, a non-cell defining synchronization signal block (NCD-SSB) occupying one or more symbols of the first CC; means for dropping at least a first symbol of the one or more symbols of the second CC based on at least one of: the NCD-SSB occupying the one or more symbols, or at least the first symbol being an uplink symbol; means for communicating, using half-duplex inter-band TDD CA via a plurality of component carriers (CCs) including a first CC and a second CC, with a plurality of cells including a reference cell and another cell, wherein the first CC is associated with the other cell and the second CC is associated with the reference cell; means for dropping a non-cell defining synchronization signal block (NCD-SSB) occupying one or more symbols of the first CC, wherein the NCD-SSB is dropped based on the one or more symbols of the second CC being configured as semi-static uplink or as radio resource control (RRC) uplink; means for communicating with a plurality of cells using half-duplex inter-band TDD CA via a plurality of component carriers (CCs); means for outputting, for transmission in response to the command enabling collision handling, an indication that the apparatus is configured for a non-legacy bandwidth part (BWP) switching delay; means for monitoring a first bandwidth-part (BWP) of one or more of the plurality of CCs; and means for switching from the first BWP to a second BWP within the non-legacy BWP switching delay.

The aforementioned means may be one or more of the aforementioned components of the apparatus 1402 configured to perform the functions recited by the aforementioned means. As described supra, the apparatus 1402 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

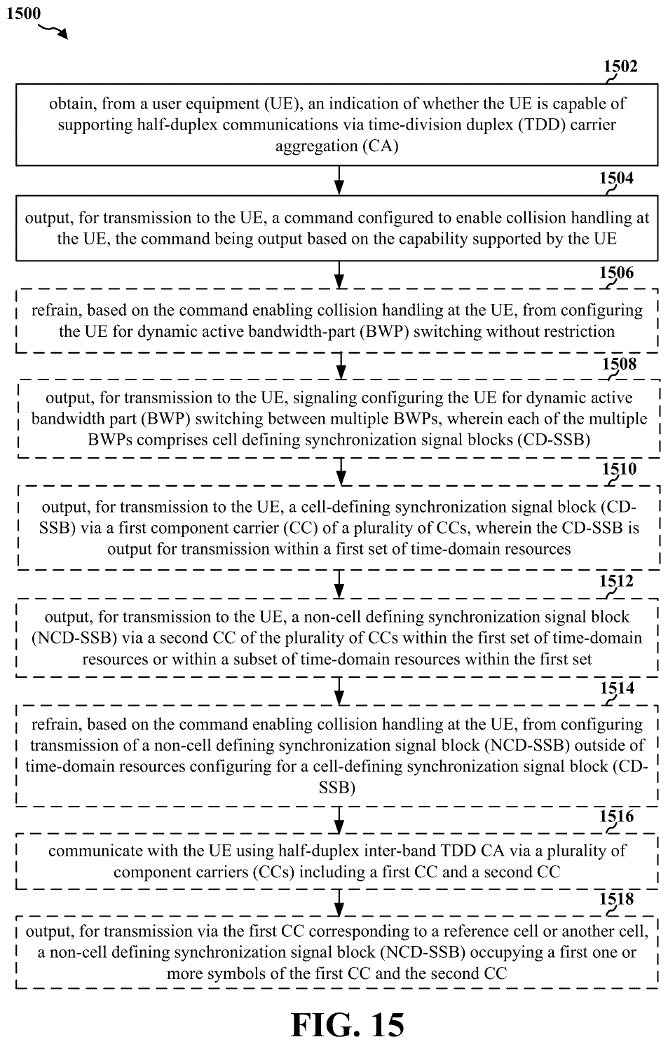

FIG. 15 is a flowchart of a method 1500 of wireless communication. The method may be performed by a network entity or base station (e.g., the base station 102/180; the apparatus 1602). The method 1500 may be performed by one or more processors (e.g., controller/processor 375, RX processor 370, TX processor 316, memory 376, etc. of FIG. 3).

At 1502, the network entity may obtain, from a user equipment (UE), an indication of whether the UE is capable of supporting half-duplex communications via time-division duplex (TDD) carrier aggregation (CA). For example, 1502 may be performed by a receiving component 1640.

At 1504, the network entity may output, for transmission to the UE, a command configured to enable collision handling at the UE, the command being output based on the capability supported by the UE. For example, 1504 may be performed by a transmitting component 1642.

At 1506, the network entity may refrain, based on the command enabling collision handling at the UE, from configuring the UE for dynamic active bandwidth-part (BWP) switching without restriction. For example, 1504 may be performed by a refraining component 1644.

At 1508, the network entity may output, for transmission to the UE, signaling configuring the UE for dynamic active bandwidth part (BWP) switching between multiple BWPs, wherein each of the multiple BWPs comprises cell defining synchronization signal blocks (CD-SSB). For example, 1504 may be performed by the transmitting component 1642.

At 1510, the network entity may output, for transmission to the UE, a cell-defining synchronization signal block (CD-SSB) via a first component carrier (CC) of a plurality of CCs, wherein the CD-SSB is output for transmission within a first set of time-domain resources. For example, 1510 may be performed by the transmitting component 1642.

At 1512, the network entity may output, for transmission to the UE, a non-cell defining synchronization signal block (NCD-SSB) via a second CC of the plurality of CCs within the first set of time-domain resources or within a subset of time-domain resources within the first set. For example, 1512 may be performed by the transmitting component 1642.

At 1514, the network entity may refrain, based on the command enabling collision handling at the UE, from configuring transmission of a non-cell defining synchronization signal block (NCD-SSB) outside of time-domain resources configuring for a cell-defining synchronization signal block (CD-SSB). For example, 1514 may be performed by the refraining component 1644.

At 1516, the network entity may communicate with the UE using half-duplex inter-band TDD CA via a plurality of component carriers (CCs) including a first CC and a second CC. For example, 1516 may be performed by the receiving component 1640 and the transmitting component 1642.

At 1518, the network entity may output, for transmission via the first CC corresponding to a reference cell or another cell, a non-cell defining synchronization signal block (NCD-SSB) occupying a first one or more symbols of the first CC and the second CC. For example, 1518 may be performed by a transmitting component 1642.

In certain aspects, the capability for half-duplex communications is associated with inter-band TDD CA.

In certain aspects, the NCD-SSB is output for transmission within the first set of time-domain resources or within the subset of time-domain resources within the first set based on the command enabling collision handling at the UE.

In certain aspects, the first CC corresponds to the reference cell, and wherein each of the first one or more symbols are configured as at least one of semi-static downlink symbols or radio resource configuration (RRC) downlink symbols.

In certain aspects, the first CC corresponds to the other cell, wherein the second CC corresponds to the reference cell, and wherein the first one or more symbols of the second CC are configured as at least one of semi-static downlink or radio resource configuration (RRC) downlink.

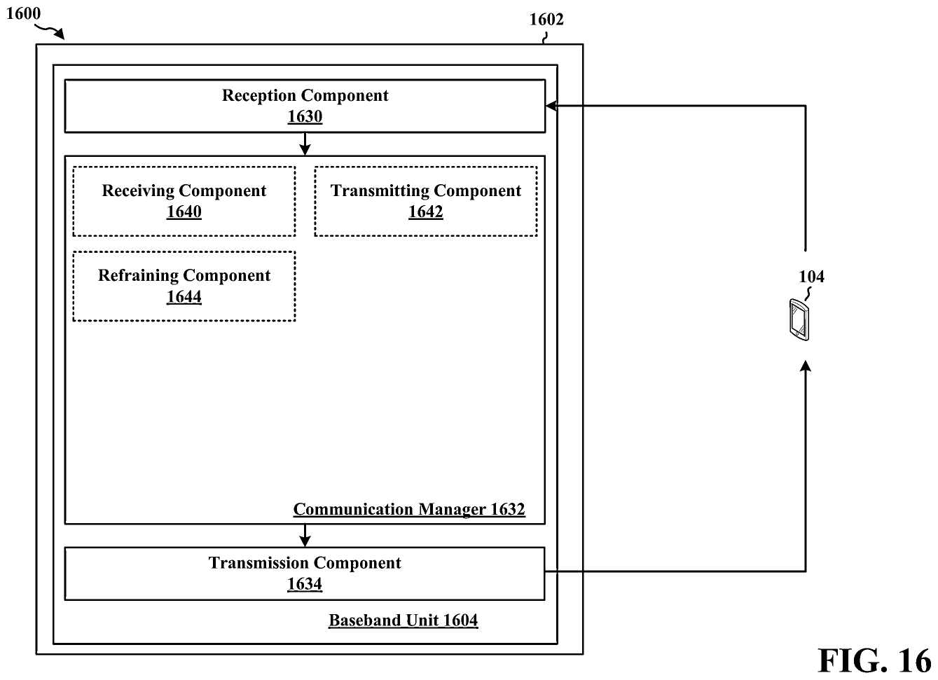

FIG. 16 is a diagram 1600 illustrating an example of a hardware implementation for an apparatus 1602. The apparatus 1602 is a BS and includes a baseband unit 1604.

The baseband unit 1604 may communicate through a cellular RF transceiver with the UE 104. The baseband unit 1604 may include a computer-readable medium/memory. The baseband unit 1604 is responsible for general processing, including the execution of software stored on the computer-readable medium/memory. The software, when executed by the baseband unit 1604, causes the baseband unit 1604 to perform the various functions described supra. The computer-readable medium/memory may also be used for storing data that is manipulated by the baseband unit 1604 when executing software. The baseband unit 1604 further includes a reception component 1630, a communication manager 1632, and a transmission component 1634. The communication manager 1632 includes the one or more illustrated components. The components within the communication manager 1632 may be stored in the computer-readable medium/memory and/or configured as hardware within the baseband unit 1604. The baseband unit 1604 may be a component of the network entity or BS 102/180 and may include the memory 376 and/or at least one of the TX processor 316, the RX processor 370, and the controller/processor 375. In various examples, the apparatus 1602 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 1632 includes a receiving component 1640 that configured to obtain, from a user equipment (UE), an indication of whether the UE is capable of supporting half-duplex communications via time-division duplex (TDD) carrier aggregation (CA); and communicate with the UE using half-duplex inter-band TDD CA via a plurality of component carriers (CCs) including a first CC and a second CC. e.g., as described in connection with 1502 and 1516.

The communication manager 1632 further includes a transmitting component 1642 configured to output, for transmission to the UE, a command configured to enable collision handling at the UE, the command being output based on the capability supported by the UE; output, for transmission to the UE, signaling configuring the UE for dynamic active bandwidth part (BWP) switching between multiple BWPs, wherein each of the multiple BWPs comprises cell defining synchronization signal blocks (CD-SSB); output, for transmission to the UE, a cell-defining synchronization signal block (CD-SSB) via a first component carrier (CC) of a plurality of CCs, wherein the CD-SSB is output for transmission within a first set of time-domain resources; output, for transmission to the UE, a non-cell defining synchronization signal block (NCD-SSB) via a second CC of the plurality of CCs within the first set of time-domain resources or within a subset of time-domain resources within the first set; and output, for transmission via the first CC corresponding to a reference cell or another cell, a non-cell defining synchronization signal block (NCD-SSB) occupying a first one or more symbols of the first CC and the second CC, e.g., as described in connection with 1504, 1508, 1510, 1512, 1516, and 1518.

The communication manager 1632 further includes a refraining component 1644 configured to refrain, based on the command enabling collision handling at the UE, from configuring the UE for dynamic active bandwidth-part (BWP) switching without restriction; and refrain, based on the command enabling collision handling at the UE, from configuring transmission of a non-cell defining synchronization signal block (NCD-SSB) outside of time-domain resources configuring for a cell-defining synchronization signal block (CD-SSB), e.g., as described in connection with 1506 and 1514.

The apparatus may include additional components that perform each of the blocks of the algorithm in the aforementioned flowchart of FIG. 15. As such, each block in the aforementioned flowchart may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1602, and in particular the baseband unit 1604, includes means for obtaining, from a user equipment (UE), an indication of whether the UE is capable of supporting half-duplex communications via time-division duplex (TDD) carrier aggregation (CA); means for outputting, for transmission to the UE, a command configured to enable collision handling at the UE, the command being output based on the capability supported by the UE; means for refraining, based on the command enabling collision handling at the UE, from configuring the UE for dynamic active bandwidth-part (BWP) switching without restriction; means for outputting, for transmission to the UE, signaling configuring the UE for dynamic active bandwidth part (BWP) switching between multiple BWPs, wherein each of the multiple BWPs comprises cell defining synchronization signal blocks (CD-SSB); means for outputting, for transmission to the UE, a cell-defining synchronization signal block (CD-SSB) via a first component carrier (CC) of a plurality of CCs, wherein the CD-SSB is output for transmission within a first set of time-domain resources; means for outputting, for transmission to the UE, a non-cell defining synchronization signal block (NCD-SSB) via a second CC of the plurality of CCs within the first set of time-domain resources or within a subset of time-domain resources within the first set; means for refraining, based on the command enabling collision handling at the UE, from configuring transmission of a non-cell defining synchronization signal block (NCD-SSB) outside of time-domain resources configuring for a cell-defining synchronization signal block (CD-SSB); means for communicating with the UE using half-duplex inter-band TDD CA via a plurality of component carriers (CCs) including a first CC and a second CC; and means for outputting, for transmission via the first CC corresponding to a reference cell or another cell, a non-cell defining synchronization signal block (NCD-SSB) occupying a first one or more symbols of the first CC and the second CC.

The aforementioned means may be one or more of the aforementioned components of the apparatus 1602 configured to perform the functions recited by the aforementioned means. As described supra, the apparatus 1602 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

### ADDITIONAL CONSIDERATIONS

Means for receiving or means for obtaining may include a receiver, such as the receive processor 356/370 and/or an antenna(s) 320/352 of the BS 102/180 and UE 104 illustrated in FIG. 3. Means for transmitting or means for outputting may include a transmitter, such as the transmit processor 316/368 and/or an antenna(s) 320/352 of the BS 102/180 and UE 104 illustrated in FIG. 3. Means for communicating may include both the means transmitting (or outputting for transmission) and the means for receiving (or obtaining). Means for dropping, means for monitoring, means for switching, and means for refraining may include a processing system and memory, which may include one or more processors and one or more memories, such as the controller/processor 375/359 and memories 176/360 of the BS 102/180 and the UE 104 illustrated in FIG. 3.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y. and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X. Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C. B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

### Example Aspects

The following examples are illustrative only and may be combined with aspects of other embodiments or teachings described herein, without limitation.

Clause 1. A method for wireless communication at an apparatus, comprising: outputting for transmission an indication of whether the apparatus is capable of supporting half-duplex communications via time-division duplex (TDD) carrier aggregation (CA); and obtaining a command configured to enable collision handling by the apparatus, the command being based on the capability supported by the apparatus.

Clause 2. The method of clause 1, wherein the capability for half-duplex communications is associated with inter-band TDD CA.

Clause 3. The method of any of clauses 1 and 2, further comprising: obtaining signaling configuring the apparatus for dynamic active bandwidth part (BWP) switching between multiple BWPs, wherein each of the multiple BWPs comprises cell defining synchronization signal blocks (CD-SSB).

Clause 4. The method of any of clauses 1-3, further comprising: communicating with a plurality of cells using half-duplex inter-band TDD CA via a plurality of component carriers (CCs); obtaining a cell-defining synchronization signal block (CD-SSB) via a first CC of the plurality of CCs within a first set of time-domain resources; and obtaining a non-cell defining synchronization signal block (NCD-SSB) via a second CC of the plurality of CCs within the first set of time-domain resources or within a subset of time-domain resources within the first set.

Clause 5. The method of clause 4, wherein the NCD-SSB is obtained via a downlink bandwidth part (BWP) of the second CC.

Clause 6. The method of any of clauses 1-5, wherein the method further comprises: communicating with a plurality of cells using half-duplex inter-band TDD CA via a plurality of component carriers (CCs) including a first CC and a second CC, wherein the plurality of cells comprise a reference cell and another cell; and obtaining, via the first CC associated with the reference cell or the other cell, a non-cell defining synchronization signal block (NCD-SSB) occupying a first one or more symbols of the first CC.

Clause 7. The method of clause 6, wherein the first CC is associated with the reference cell, and wherein the first one or more symbols are configured as at least one of semi-static downlink symbols or radio resource configuration (RRC) downlink symbols.

Clause 8. The method of any of clauses 6 and 7, wherein the first CC is associated with the other cell and the second CC is associated with the reference cell, and wherein the first one or more symbols of the second CC are configured as at least one of semi-static downlink symbols or radio resource configuration (RRC) downlink symbols.

Clause 9. The method of any of clauses 1-8, wherein the method further comprises: communicating, using half-duplex inter-band TDD CA via a plurality of component carriers (CCs), with a plurality of cells including a reference cell and another cell, wherein the plurality of CCs include a first CC associated with the reference cell and a second CC associated with the other cell; obtaining, via the first CC, a non-cell defining synchronization signal block (NCD-SSB) occupying one or more symbols of the first CC; and dropping at least a first symbol of the one or more symbols of the second CC based on at least one of: the NCD-SSB occupying the one or more symbols, or at least the first symbol being an uplink symbol.

Clause 10. The method of any of clauses 1-9, wherein the method further comprises: communicating, using half-duplex inter-band TDD CA via a plurality of component carriers (CCs) including a first CC and a second CC, with a plurality of cells including a reference cell and another cell, wherein the first CC is associated with the other cell and the second CC is associated with the reference cell; and dropping a non-cell defining synchronization signal block (NCD-SSB) occupying one or more symbols of the first CC, wherein the NCD-SSB is dropped based on the one or more symbols of the second CC being configured as semi-static uplink or as radio resource control (RRC) uplink.

Clause 11. The method of clause 10, wherein the NCD-SSB is dropped based further on the second CC being associated with the reference cell and the reference cell having priority over the other cell.

Clause 12. The method of any of clauses 1-11, wherein the method further comprises: communicating with a plurality of cells using half-duplex inter-band TDD CA via a plurality of component carriers (CCs); and outputting, for transmission in response to the command enabling collision handling, an indication that the apparatus is configured for a non-legacy bandwidth part (BWP) switching delay.

Clause 13. The method of clause 12, wherein the one or more processors, individually or in combination, are further configured to cause the apparatus to: monitoring a first bandwidth-part (BWP) of one or more of the plurality of CCs; and switching from the first BWP to a second BWP within the non-legacy BWP switching delay.

Clause 14. The method of any of clauses 12 and 13, wherein the non-legacy BWP switching delay has a longer duration relative to a legacy switching delay.

Clause 15. A method for wireless communication at an apparatus, comprising: obtaining, from a user equipment (UE), an indication of whether the UE is capable of supporting half-duplex communications via time-division duplex (TDD) carrier aggregation (CA); and outputting, for transmission to the UE, a command configured to enable collision handling at the UE, the command being output based on the capability supported by the UE.

Clause 16. The method of clause 15, wherein the capability for half-duplex communications is associated with inter-band TDD CA.

Clause 17. The method of any of clauses 15 and 16, wherein the method further comprises: refraining, based on the command enabling collision handling at the UE, from configuring the UE for dynamic active bandwidth-part (BWP) switching without restriction.

Clause 18. The method of any of clauses 15-17, wherein the method further comprises: outputting, for transmission to the UE, signaling configuring the UE for dynamic active bandwidth part (BWP) switching between multiple BWPs, wherein each of the multiple BWPs comprises cell defining synchronization signal blocks (CD-SSB).

Clause 19. The method of any of clauses 15-18, wherein the method further comprises: outputting, for transmission to the UE, a cell-defining synchronization signal block (CD-SSB) via a first component carrier (CC) of a plurality of CCs, wherein the CD-SSB is output for transmission within a first set of time-domain resources; and outputting, for transmission to the UE, a non-cell defining synchronization signal block (NCD-SSB) via a second CC of the plurality of CCs within the first set of time-domain resources or within a subset of time-domain resources within the first set.

Clause 20. The method of clause 19, wherein the NCD-SSB is output for transmission within the first set of time-domain resources or within the subset of time-domain resources within the first set based on the command enabling collision handling at the UE.

Clause 21. The method of any of clauses 15-20, wherein the method further comprises: refraining, based on the command enabling collision handling at the UE, from configuring transmission of a non-cell defining synchronization signal block (NCD-SSB) outside of time-domain resources configuring for a cell-defining synchronization signal block (CD-SSB).

Clause 22. The method of any of clauses 15-21, wherein the method further comprises: communicating with the UE using half-duplex inter-band TDD CA via a plurality of component carriers (CCs) including a first CC and a second CC; and outputting, for transmission via the first CC corresponding to a reference cell or another cell, a non-cell defining synchronization signal block (NCD-SSB) occupying a first one or more symbols of the first CC and the second CC.

Clause 23. The method of clause 22, wherein the first CC corresponds to the reference cell, and wherein each of the first one or more symbols are configured as at least one of semi-static downlink symbols or radio resource configuration (RRC) downlink symbols.

Clause 24. The method of any of clauses 22 and 23, wherein the first CC corresponds to the other cell, wherein the second CC corresponds to the reference cell, and wherein the first one or more symbols of the second CC are configured as at least one of semi-static downlink or radio resource configuration (RRC) downlink.

Clause 25. A user equipment (UE), comprising: a transceiver; one or more memories, individually or in combination, having instructions; and one or more processors, individually or in combination, configured to execute the instructions and cause the UE to perform a method in accordance with any one of examples 1-14, wherein the transceiver is configured to: transmit the indication of whether the UE is capable of supporting half-duplex communications; and receive the command configured to enable collision handling by the UE.

Clause 26. A network entity, comprising: a transceiver; one or more memories, individually or in combination, having instructions; and one or more processors, individually or in combination, configured to execute the instructions and cause the network entity to perform a method in accordance with any one of examples 15-24, wherein the transceiver is configured to: receive the indication of whether the UE is capable of supporting half-duplex communications; and transmit the command configured to enable collision handling at the UE

Clause 27. An apparatus for wireless communications, comprising means for performing a method in accordance with any one of examples 1-14.

Clause 28. An apparatus for wireless communications, comprising means for performing a method in accordance with any one of examples 15-24.

Clause 29. A non-transitory computer-readable medium comprising instructions that, when executed by an apparatus, cause the apparatus to perform a method in accordance with any one of examples 1-14.

Clause 30. A non-transitory computer-readable medium comprising instructions that, when executed by an apparatus, cause the apparatus to perform a method in accordance with any one of examples 15-24.

Clause 31. An apparatus for wireless communications, comprising: one or more memories, individually or in combination, having instructions; and one or more processors, individually or in combination, configured to execute the instructions and cause the apparatus to perform a method in accordance with any one of examples 1-14.

Clause 32. An apparatus for wireless communications, comprising: one or more memories, individually or in combination, having instructions; and one or more processors, individually or in combination, configured to execute the instructions and cause the apparatus to perform a method in accordance with any one of examples 15-24.

What is claimed is:

1. An apparatus for wireless communication, comprising:
one or more memories, individually or in combination, having instructions; and
one or more processors, individually or in combination, configured to execute the instructions and cause the apparatus to:
output for transmission an indication of whether the apparatus is capable of supporting half-duplex communications via time-division duplex (TDD) carrier aggregation (CA); and
obtain a command configured to enable collision handling by the apparatus, the command being based on the capability supported by the apparatus.

2. The apparatus of claim 1, wherein the capability for half-duplex communications is associated with inter-band TDD CA.

3. The apparatus of claim 1, wherein the one or more processors, individually or in combination, are further configured to cause the apparatus to:
obtain signaling configuring the apparatus for dynamic active bandwidth part (BWP) switching between multiple BWPs, wherein each of the multiple BWPs comprises cell defining synchronization signal blocks (CD-SSB).

4. The apparatus of claim 1, wherein the one or more processors, individually or in combination, are further configured to cause the apparatus to:
communicate with a plurality of cells using half-duplex inter-band TDD CA via a plurality of component carriers (CCs);
obtain a cell-defining synchronization signal block (CD-SSB) via a first CC of the plurality of CCs within a first set of time-domain resources; and
obtain a non-cell defining synchronization signal block (NCD-SSB) via a second CC of the plurality of CCs within the first set of time-domain resources or within a subset of time-domain resources within the first set.

5. The apparatus of claim 4, wherein the NCD-SSB is obtained via a downlink bandwidth part (BWP) of the second CC.

6. The apparatus of claim 1, wherein the one or more processors, individually or in combination, are further configured to cause the apparatus to:
communicate with a plurality of cells using half-duplex inter-band TDD CA via a plurality of component carriers (CCs) including a first CC and a second CC, wherein the plurality of cells comprise a reference cell and another cell; and
obtain, via the first CC associated with the reference cell or the other cell, a non-cell defining synchronization signal block (NCD-SSB) occupying a first one or more symbols of the first CC.

7. The apparatus of claim 6, wherein the first CC is associated with the reference cell, and wherein the first one or more symbols are configured as at least one of semi-static downlink symbols or radio resource configuration (RRC) downlink symbols.

8. The apparatus of claim 6, wherein the first CC is associated with the other cell and the second CC is associated with the reference cell, and wherein the first one or more symbols of the second CC are configured as at least one of semi-static downlink symbols or radio resource configuration (RRC) downlink symbols.

9. The apparatus of claim 1, wherein the one or more processors, individually or in combination, are further configured to cause the apparatus to:
communicate, using half-duplex inter-band TDD CA via a plurality of component carriers (CCs), with a plurality of cells including a reference cell and another cell, wherein the plurality of CCs include a first CC associated with the reference cell and a second CC associated with the other cell;
obtain, via the first CC, a non-cell defining synchronization signal block (NCD-SSB) occupying one or more symbols of the first CC; and
drop at least a first symbol of the one or more symbols of the second CC based on at least one of:
the NCD-SSB occupying the one or more symbols, or
at least the first symbol being an uplink symbol.

10. The apparatus of claim 1, wherein the one or more processors, individually or in combination, are further configured to cause the apparatus to:
communicate, using half-duplex inter-band TDD CA via a plurality of component carriers (CCs) including a first CC and a second CC, with a plurality of cells including a reference cell and another cell, wherein the first CC is associated with the other cell and the second CC is associated with the reference cell; and
drop a non-cell defining synchronization signal block (NCD-SSB) occupying one or more symbols of the first CC, wherein the NCD-SSB is dropped based on the one or more symbols of the second CC being configured as semi-static uplink or as radio resource control (RRC) uplink.

11. The apparatus of claim 10, wherein the NCD-SSB is dropped based further on the second CC being associated with the reference cell and the reference cell having priority over the other cell.

12. The apparatus of claim 1, wherein the one or more processors, individually or in combination, are further configured to cause the apparatus to:
communicate with a plurality of cells using half-duplex inter-band TDD CA via a plurality of component carriers (CCs); and
output, for transmission in response to the command enabling collision handling, an indication that the apparatus is configured for a non-legacy bandwidth part (BWP) switching delay.

13. The apparatus of claim 12, wherein the one or more processors, individually or in combination, are further configured to cause the apparatus to:
monitor a first bandwidth-part (BWP) of one or more of the plurality of CCs; and
switch from the first BWP to a second BWP within the non-legacy BWP switching delay.

14. The apparatus of claim 12, wherein the non-legacy BWP switching delay has a longer duration relative to a legacy switching delay.

15. The apparatus of claim 1, further comprising a transceiver configured to:
transmit the indication of whether the apparatus is capable of supporting half-duplex communications via TDD CA; and
receive the command configured to enable collision handling by the apparatus, wherein the apparatus is configured as a user equipment (UE).

16. An apparatus for wireless communication, comprising:
one or more memories, individually or in combination, having instructions; and
one or more processors, individually or in combination, configured to execute the instructions and cause the apparatus to:
obtain, from a user equipment (UE), an indication of whether the UE is capable of supporting half-duplex communications via time-division duplex (TDD) carrier aggregation (CA); and
output, for transmission to the UE, a command configured to enable collision handling at the UE, the command being output based on the capability supported by the UE.

17. The apparatus of claim 16, wherein the capability for half-duplex communications is associated with inter-band TDD CA.

18. The apparatus of claim 16, wherein the one or more processors, individually or in combination, are further configured to cause the apparatus to:
refrain, based on the command enabling collision handling at the UE, from configuring the UE for dynamic active bandwidth-part (BWP) switching without restriction.

19. The apparatus of claim 16, wherein the one or more processors, individually or in combination, are further configured to cause the apparatus to:
output, for transmission to the UE, signaling configuring the UE for dynamic active bandwidth part (BWP) switching between multiple BWPs, wherein each of the multiple BWPs comprises cell defining synchronization signal blocks (CD-SSB).

20. The apparatus of claim 16, wherein the one or more processors, individually or in combination, are further configured to cause the apparatus to:
output, for transmission to the UE, a cell-defining synchronization signal block (CD-SSB) via a first component carrier (CC) of a plurality of CCs, wherein the CD-SSB is output for transmission within a first set of time-domain resources; and
output, for transmission to the UE, a non-cell defining synchronization signal block (NCD-SSB) via a second CC of the plurality of CCs within the first set of time-domain resources or within a subset of time-domain resources within the first set.

21. The apparatus of claim 20, wherein the NCD-SSB is output for transmission within the first set of time-domain resources or within the subset of time-domain resources within the first set based on the command enabling collision handling at the UE.

22. The apparatus of claim 16, wherein the one or more processors, individually or in combination, are further configured to cause the apparatus to:
refrain, based on the command enabling collision handling at the UE, from configuring transmission of a non-cell defining synchronization signal block (NCD-SSB) outside of time-domain resources configuring for a cell-defining synchronization signal block (CD-SSB).

23. The apparatus of claim 16, wherein the one or more processors, individually or in combination, are further configured to cause the apparatus to:
communicate with the UE using half-duplex inter-band TDD CA via a plurality of component carriers (CCs) including a first CC and a second CC; and
output, for transmission via the first CC corresponding to a reference cell or another cell, a non-cell defining synchronization signal block (NCD-SSB) occupying a first one or more symbols of the first CC and the second CC.

24. The apparatus of claim 23, wherein the first CC corresponds to the reference cell, and wherein each of the first one or more symbols are configured as at least one of semi-static downlink symbols or radio resource configuration (RRC) downlink symbols.

25. The apparatus of claim 23, wherein the first CC corresponds to the other cell, wherein the second CC corresponds to the reference cell, and wherein the first one or more symbols of the second CC are configured as at least one of semi-static downlink or radio resource configuration (RRC) downlink.

26. The apparatus of claim 16, further comprising a transceiver configured to:
receive the indication of whether the UE is capable of supporting half-duplex communications via TDD CA; and
transmit the command configured to enable collision handling at the UE, wherein the apparatus is configured as a network entity.

27. A method for wireless communications at a wireless node, comprising:
outputting for transmission an indication of whether the wireless node is capable of supporting half-duplex communications via time-division duplex (TDD) carrier aggregation (CA); and
obtaining a command configured to enable collision handling by the wireless node, the command being based on the capability supported by the wireless node.
